(19) United States
(12) Patent Application Publication
(10) Pub. No.: US 2025/0098684 A1
(43) Pub. Date: Mar. 27, 2025

(54) CROP NUTRITION COMPOSITION

(71) Applicant: Komal BHUKHANWALA, Mumbai (IN)

(72) Inventor: Harsha Ramanand NAIK, Thane (IN)

(73) Assignee: Komal BHUKHANWALA, Mumbai, MH (IN)

(21) Appl. No.: 18/576,975

(22) PCT Filed: Jul. 7, 2022
(86) PCT No.: PCT/IB2022/056296

§ 371 Date: Jan. 5, 2024

(30) Foreign Application Priority Data
Jul. 7, 2021 (IN) 202121030573

(51) Int. Cl. A01N 59/16; A01N 59/06; A01P 21/00

(52) U.S. Cl. CPC A01N 59/16; A01N 59/06; A01P 21/00

(57) ABSTRACT

The present invention relates to a crop nutrition composition in the form of water dispersible granules comprising a homogeneous mixture of one or more of water insoluble Magnesium salt, complex or derivative thereof in the range of 1-80% w/w of the total composition and one or more of water insoluble Zinc salt, complex or derivative thereof in the range of 1-50% w/w of the total composition and one or more of water insoluble Iron salt, complex or derivative thereof in the range of 1-50% w/w of the total composition with at least one agrochemically acceptable excipient in the range of 0.01-97% w/w of the total composition; wherein the granules of the composition are in the size range of 0.05 mm-4.0 mm and comprises of particles in the size range of 0.1 micron-20 microns. The present invention further relates to a method of treating plants and meeting their nutritional requirement by making essential nutrients like Magnesium, Zinc and Iron available to them and also unlocking other micronutrients and trace elements present in the soil which hitherto were not available because of various factors primarily being soil degradation on account of excessive use of synthetic fertilizers. The present invention also relates to strengthening the plants so as to withstand pest infestation. The present invention also relates to a method of biofortification of plant with essential micronutrients.

### FIELD OF THE INVENTION

The present invention relates to a crop nutrition composition in the form of water dispersible granules comprising a homogeneous mixture an effective amount of one or more of water insoluble Magnesium salt, complex or derivative thereof and one or more of water insoluble Zinc salt, complex or derivative thereof and one or more of water insoluble Iron salt, complex or derivative thereof with at least one agrochemically acceptable excipient. The water dispersible granular composition of the present invention is in the size range of 0.05 mm-4.0 mm and comprises of particles in the size range of 0.1 micron to 20 microns.

The invention further relates to a water dispersible granular composition comprising a homogeneous mixture of one or more of water insoluble Magnesium salt, complex or derivative thereof in the range of 1%-80% w/w of the total composition and one or more of water insoluble Zinc salt, complex or derivative thereof in the range of 1%-50% w/w of the total composition and one or more of water insoluble Iron salt, complex or derivative thereof in the range of 1%-50% w/w of the total composition with at least one agrochemically acceptable excipient in the range of 0.01%-97% w/w of the total composition; wherein the granules of the composition are in the size range of 0.05 mm-4.0 mm and comprises of particles in the size range of 0.1 micron to 20 microns.

The present invention further relates to a method of treating plants and meeting their nutritional requirement by making essential nutrients like Magnesium, Zinc and Iron available to them and also unlocking other micronutrients and trace elements present in the soil which hitherto were not available because of various factors primarily being soil degradation on account of excessive use of synthetic fertilizers.

The present invention also relates to strengthening the plants so as to withstand pest infestation.

The present invention also relates to a method of biofortification of plant with essential micronutrients.

### BACKGROUND OF THE INVENTION

In describing the embodiments of the invention, specific terminology is chosen for the sake of clarity. However, it is not intended that the invention be limited to the specific terms so selected and it is to be understood that each specific term includes all technical equivalents that operate in a similar manner to accomplish a similar purpose.

Nutrition is the key element in growth and development of crops. Poor and inadequate availability of nutrients to the plants results in lack of proper growth and physiological development. As a consequence, the plants become more susceptible to attack by pests. Other problems associated with agriculture are environmental conditions such as drought, biotic and abiotic stress, poor soil condition or depletion of nutrients in the soil which lead to reduction in the yield and quality of produce. Thus, providing adequate and balanced nutrition in a manner such that there is maximum uptake of nutrient by the plant, along with protection to the crops remains a great challenge. Optimizing the soil condition and managing the use of crop nutrients has been a long felt need of farmers to improve the nutrient use efficiency of crops. Significant research is being carried out so as to improve soil and plant health, provide better economic returns to farmers and also reduce the burden on the environment because of rampant use of synthetic pesticides.

In parallel, hidden hunger and micronutrient deficiencies across population in all major continents is rampant which contribute substantially to the global burden of diseases. Amongst the micronutrient deficiencies that people are normally suffering across the globe, Iron (Fe) and Zinc (Zn) are two important nutrients found in human nutrition and are amongst the most common micronutrient deficiencies in the world. Fe deficiency is seen in 20%-25% of the world population and Zn deficiency is seen in 17.3% of the world population (Cooper et al. 2012). One of the key underlying causes of this is the imbalanced fertilizer practice. Excessive and indiscriminate application of nutrients can cause severe imbalance and antagonism which results in nutrient deficient produce. It is thus a herculean and challenging task to grow food in quantity while maintaining quality in terms of nutrient content.

Further, modern agriculture is challenged by degraded soils on account of excessive use of synthetic fertilizers such as nitrogen, phosphatic and potash-based fertilizers, excessive cultivation, which in turn produce crops and harvest that are devoid of nutrients finally affecting human nutrition and health. More than 30% of the earth surface is covered by Calcareous soil which also pose a challenge in terms of providing adequate Zinc and Iron nutrients to the crop. Besides, the increasing labor & water shortage, demand for high and quality yields, current farming practices are greatly challenged by deteriorating soil health, depletion of water table, decreasing fertility of soil, leaching of fertilizers and pesticides, micronutrient deficiencies in the soil, and so on. The use of excessive synthetic fertilizers has led to huge imbalance of soil nutrients. Almost more than double the amount of fertilizers such as Nitrogen, Phosphorous and Potassium have been applied nowadays to the soil than they were applied 20 or 30 years ago to achieve similar yields. It was observed that excessive nitrogen fertilizer leads to a reduction of exchangeable Calcium and Magnesium ions in the soil, making it unavailable to the plant which in turn results in retardation of plant growth and soil health. Also, the long-term use of synthetic NPK fertilizers make the soils acidic, degraded and also limits the uptake of other vital nutrients including Zinc, Iron, Calcium and Magnesium. The excessive amounts of Nitrogen, Phosphorous and Calcium, in the soil further lead to a nutrient imbalance and the final produce is devoid of essential nutrients, particularly Zinc and Iron (due to excessive Phosphorous) and Magnesium (due to excessive Calcium and Nitrogen).

The role of micronutrients as an essential element required for growth and reproduction by plants has been long known. Micronutrients plays an important role in balancing the crop nutrition. Further, it is also known that optimum levels of nutrients are required for the normal functioning, growth of the plants and any variance in the nutrient levels may cause hindrance in overall crop growth and cause its health to decline due to either a deficiency or toxicity. Poor availability of fertilizers or nutrients to the plants results in a lack of proper growth, resulting in the plants becoming more susceptible to attack by pests. In fact, it is also observed that even though there are some soil types that are carrying adequate amounts of micronutrients including Iron, Zinc and other elements, their bioavailability for crop uptake is limited due to various factors and the final harvest is deficient in these nutrients.

Besides the low concentration of essential micronutrients in soil, one of the root causes for the deficiency is the low availability of micronutrients in its oxidized form to plant roots. Further, leaching of water-soluble nutrients due to rain and irrigation also reduces the availability of nutrients in soil. Furthermore, managing nutrition of crops is difficult due to factors such as variable carbonate levels in soil, soil salinity, soil moisture, soil alkalinity, low temperature and concentration of other elements i.e. ‘competitive microelements’ which may also affect the availability of the micronutrients and at times lead to the deficiency of the micronutrients. Further, the ability of plants to respond to the availability of micronutrients ultimately affects human nutrition, both in terms of crop yield and the micronutrient concentration in the edible tissues. Therefore, proper nutrition is critical for optimizing the plant nutrition and metabolism, which in turn contributes to the overall crop yield and quality.

The interaction among plant nutrients can either be antagonistic or synergistic depending upon the mixture of elements and its composition, concentration etc. and that may influence nutrient use efficiency. Due to application of excess nutrients, plants may suffer from “nutrient antagonism” whereby an excess of a particular element may block the absorption of another element required by the plant and can happen with elements of a similar size and charge (positive or negative) which can result into deficiencies in the plant. Some of the most common antagonisms are iron blocking zinc, manganese (or the reverse), magnesium blocking calcium (or the reverse) and potassium blocking both magnesium and calcium. Another reason for a plant being deficient is “Binding” which occurs when elements mix together and bond, forming a compound that is insoluble and cannot be absorbed by plant's roots. Thus, it is imperative to apply balance amounts of the most limiting nutrients to obtain the highest yield while minimizing nutrient losses. One of the articles titled “Iron-magnesium antagonism in growth and metabolism of radish; Agarwala S. C, and S. C. Mehrotra et al; 1984” (reported the iron-magnesium antagonism in crops while another article titled “Effects of Nutrient Antagonism and Synergism on Yield and Fertilizer Use Efficiency; René P. J. J. Rietra, Marius Heinen et al; 2017” reported antagonism between Zinc and Magnesium. Further, antagonism between Fe and Zn is also well known (Alloway, 2008 & Kabata-Pendias, 2001).

Magnesium (Mg) is an essential macro element that is necessary for plant growth, health and development. Magnesium is involved in several different processes, including photosynthesis. The most important role of Magnesium is as a central atom or heart in the chlorophyll molecule. Without Magnesium, chlorophyll cannot capture Sun's energy required for photosynthesis. Magnesium also helps to activate specific enzyme system which are involved in a plant's normal metabolism. Furthermore, it is also needed for cell division and protein formation and is an essential component for plant respiration.

The availability of Magnesium in the soil depends on multiple factors. One of them being the source rock material, the degree of weathering, local climate and specific agricultural system, its management practices, such as crop type, cropping intensity, cropping rotation and fertilization practices. Due to its high mobility within the plant, Magnesium deficiency symptoms appear first on the lower and older leaves, before the symptoms become visible on the younger leaves. The symptoms show up as yellow leaves with green veins and around the edges (i.e. interveinal chlorosis). Purple, red or brown spots may also appear on the leaves. Magnesium and its importance in crop production and agriculture has been overlooked for some time, even though it is an essential element for plant growth and development. This is due to the fact that it is difficult to detect latent Magnesium deficiency.

Further, Iron (Fe) is also an essential nutrient element required for plant or crop growth, development and reproduction, however in relatively small amounts, thus making it a micronutrient. Iron is involved in many important physiological processes in plants such as the manufacturing process of chlorophyll and a range of enzymes and proteins. It also plays a vital role in respiration, nitrogen fixation, energy transfer and metabolism in crops and plants. Iron is relatively immobile ion and once incorporated into the tissues remain in the upper parts of the plants. As a result, the translocation of Iron from one plant part to another is restricted which leads to Iron deficiency. Such deficiency in plants or crops is commonly responsible for chlorosis (yellowing). Moreover, poor Iron nutrition also results in poor nodulation of legume crops, leading to reduced size and yield.

It was observed that managing Iron nutrition of crops is difficult due to factors such as carbonate levels in the soil, salinity, soil moisture, soil alkalinity, low temperature, and concentration of other nutrient elements (e.g. competitive microelements such as Phosphorus, Calcium) which may also affect the Iron availability and at times leads to Iron deficiency. Also, the ability of plants to respond to Iron availability not only impacts the crop yield and the iron concentration in the edible plant tissues but ultimately affects the plant nutrition. Therefore, proper Iron assimilation by the crops is critical for optimizing crop nutrition and metabolism, which in turn contribute to the overall crop yield and quality.

The role of Zinc (Zn) as an essential micronutrient has also been long known. It is an important constituent of several enzymes, proteins that are responsible for driving many metabolic reactions in crops and also crucial to plant development. Zinc activates enzymes that are responsible for the synthesis of certain proteins. It is used in the formation of chlorophyll and some carbohydrates, conversion of starches to sugars and its presence in plant tissue helps the plant to withstand cold temperatures. Zinc is an essential element in the formation of auxins which help with growth regulation and stem elongation.

Zinc is immobile, due to which the deficiency symptoms occur in the new leaves. Typically, they are expressed as some varying pattern of chlorosis of the new leaves (often interveinal) and necrotic spots may form on the margins or leaf tips which results in formation of leaves which are smaller in size and often cupped upward or distorted. The symptoms also include poor bud development resulting in reduced flowering and branching, shorter internodes, giving a rosette appearance to the plant. Carbohydrate, protein, and chlorophyll formation is significantly reduced in Zinc-deficient plants. Therefore, a constant and continuous supply of Zinc is needed for optimum growth and maximum yield.

Though the benefits of micronutrients are well known, its deficiency has become widespread over the past several decades in most of the agricultural areas of the world, resulting in micronutrients being indicated as a limiting factor to improved plant growth, high yield and fertilizer efficiency.

Agricultural compositions which include micronutrient combinations are known in the art mostly in the form of powder or dust wherein the micronutrients are blended and mixed together. However, such powder-based compositions would lead to a non-uniform or non-homogeneous mixture of actives which may not be desirable in terms of its application and also poor uptake of the nutrition by the plants. Powder composition not only have issues with respect to practical application like generation of dust but also pose risk to the users mostly because of eye irritation, inhalation risk and skin irritation. Such formulations are also not easily dispersible and tend to clog the nozzles when applied via drip, making it unsuitable for use in irrigation system. Further, these compositions have also been found to have poor suspensibility which lead to random and non-uniform distribution of active ingredient on the target area which would cause undesirable effects and pose a problem in effective delivery of nutrients to the plant or crop and are also required to be used in large amounts.

Conventionally, micronutrient-based compositions are also known in the art in the form of bentonite granules or pastilles, pellets, granules prepared through molten process etc. Such products of micronutrient combinations in the form of granules or pellets or pastilles comprises of swelling clays and have been associated with several drawbacks. These compositions are generally bigger in size and include swelling clay which swell on contact with moisture and disintegrate into large particles of uneven size. Such granules or pastilles also lead to an irregular release of the micronutrients not meeting the plant nutritional requirement and eventually resulting in poor field efficacy. Again, these types of micronutrient compositions are only suitable for broadcast applications, owing to their own disadvantages namely poor dispersion and suspensibility in water because of its disintegration into larger particle size, resulting in nozzle clogging in spray applications, posing a problem in delivery of nutrients to the plants or the crops. Due to these drawbacks, such prior art compositions containing micronutrients have negligible commercially viability or applicability in drip or sprinkler irrigation system which today is an essential mode of irrigation on account of labour shortage and water scarcity.

There are granular or powder compositions known in the art which involve the use of water-soluble nutrients. However, such compositions during heavy rainfall or irrigation tend to wash away and fail to be absorbed by the plants which in turn causes ground water contamination. As soils become more saline, plants are unable to draw as much water and nutrients from the soil. This results not only in a marked loss of efficiency but also has serious environmental consequence.

Compositions comprising fertilizer granules coated with micronutrient mixtures or water disintegrable granules of micronutrients are also known in the art.

However, such compositions are designed in a manner such that they release the actives very slowly making the actives locked in the soil for prolonged period of time depriving the plant of their immediate nutritional requirement. As a consequence of the nutritional deficiency in the plants during their infancy, it makes them susceptible to various diseases eventually stunting their growth and yield. Further, water disintegrable granular compositions owing to non-uniform disintegration and distribution of particles suffer from their own set of drawbacks. On account of disintegration into random and non-uniform particles sizes, such compositions tend to clog the nozzles when applied via drip, making it unsuitable for use in modern day irrigation system.

Furthermore, other formulations disclosed in the art would direct a person to arrive at liquid compositions. However, such compositions carry low load of active due to the presence of large amount of solvents as a carrier and thus not very effective to meet the nutritional requirement of plant. Also, being liquid, they are not viable while transportation of large quantities of such products.

No suitable water dispersible granular composition comprising Magnesium in combination with Iron and Zinc is known, which would make them available to the plant in effective quantities thus meeting the balance nutritional requirement of plants and address the drawbacks like nutrient antagonism of such compositions known in the art.

Despite the known antagonism between Zn—Fe, Zn—Mg and Mg—Zn, it has always been challenging to develop an agricultural composition that overcome this problem and successfully meet the nutritional requirement of plants. The present inventors surprisingly found that the composition of the present invention comprising Magnesium, Zinc and Iron was not only effective in overcoming the antagonism amongst these individual nutrients but also exhibited synergistic effect. It was found that the composition of the present invention when formulated at a specific particle size made the nutrients Magnesium, Zinc and Iron readily available for uptake by the plants. It was also noted by the present inventors that the application of the composition renders a greater and balanced uptake of not only Magnesium, Iron and Zinc but of other nutrients that remained entrapped in the soil and provide a natural biofortification solution in a sustainable manner, even in degraded soils.

It was observed that the surprising effect was noted when the present composition comprising a combination of water insoluble salts, complex or derivatives of Magnesium, Zinc and Iron in specific proportions was formulated into a water dispersible granular form along with a specific particle size distribution. The composition of the present invention was found to address the challenges of nutrient antagonism in the soil namely between Zinc and Iron, Magnesium and Zinc, Magnesium and Iron, etc. The present composition was further observed to prevent the leaching of these nutrients and make them available to the fullest extent for the uptake by crops and increase the overall yield.

It is known in the art that optimum absorption of majority of micronutrients or macronutrients by plants occur in soils at acidic or neutral pH. However, the inventors of the present invention surprisingly discovered that the composition of the present invention provided uptake of nutrients even in soils with alkaline pH or calcareous soils. So, in addition to overcome the challenge of nutrient antagonism, the composition of the present invention was found to be effective on all soil types making it a very viable composition for all geography. Further, it was noted that the presence of Magnesium (Mg) along with Zinc and Iron in the form of the composition of the present invention facilitated not only an uptake of significant proportion of Iron (Fe) and Zinc (Zn) present in the composition but also enabled plant uptake of micro nutrients like Boron (B), Manganese (Mn), Calcium (Ca) etc entrapped in the soil.

The composition of the present invention was found to play a vital role in regulating soil pH and facilitating the uptake of nutrients even in soils which have been degraded or whose pH have been altered because of excessive use of synthetic fertilizers. The composition of the present invention met the nutritional need of plants by providing a balanced uptake of essential nutrients like Zinc, Iron and Magnesium, thus overcoming the challenge of providing a nutrient rich crop in calcareous soils which is known to provide an antagonism challenge for the uptake of these nutrients especially Iron, Zinc and Magnesium (Singh et.al., 1990, 1993). It was further surprising to observe that the balanced uptake of nutrients leads to a healthier plant that could withstand pest infestation, a higher nutrient harvest in all soils types and finally improving the overall soil health. The present composition acts as a nutrient use efficient composition while meeting the need of crops by providing a multi nutritive solution with improved uptake by crops in a single application.

The inventors of the present application have determined that the crop nutrition composition in the form of water dispersible granules comprising a homogeneous mixture of an effective amount of one or more of water insoluble Magnesium salt, complex or derivative thereof and an effective amount of one or more of water insoluble Zinc salt, complex or derivative thereof and an effective amount of one or more of water insoluble Iron salt, complex or derivative thereof with at least one agrochemically acceptable excipient; wherein the granules of the composition are in the size range of 0.05 mm-4.0 mm and comprises of particles in the size range of 0.1 micron to 20 microns demonstrate excellent field efficacy. The composition of the present invention further assists in regulating the soil pH so as to facilitate the balance uptake of micronutrients.

The composition of the present invention also exhibits superior physical characteristics such as suspensibility, dispersibility and wettabilty.

### SUMMARY OF THE INVENTION

The inventors have determined that a crop nutrition composition in the form of water dispersible granules comprising a homogeneous mixture of an effective amount of one or more of water insoluble Magnesium salt, complex or derivative thereof and an effective amount of one or more of water insoluble Zinc salt, complex or derivative thereof and an effective amount of one or more of water insoluble Iron salt, complex or derivative thereof with at least one agrochemically acceptable excipient, provides the nutrients Magnesium, Zinc and Iron readily available for uptake by the plants and increase the overall yield in various crops and improves plant physiological parameters.

The water dispersible granules of the present application comprises one or more water insoluble Iron salt, complex or derivative thereof in a concentration range of 1% to 50% by weight of the total composition, one or more water insoluble Magnesium salt, complex or derivative thereof in a concentration range of 1% to 80% by weight of the total composition, one or more water insoluble Zinc salt, complex or derivative thereof in a concentration range of 1% to 50% by weight of the total composition and at least one agrochemically acceptable excipient in the range of 0.01%-97% by weight of the total composition.

Further, the water dispersible granular crop nutrition composition comprises granules in the size range of 0.05 mm-4.0 mm which disperses into fine particles in the size range of 0.1 micron to 20 microns.

Furthermore, the invention relates to a process for preparing a crop nutrition composition in the form of water dispersible granules comprising a homogeneous mixture of an effective amount of one or more of water insoluble Magnesium salt, complex or derivative thereof and an effective amount of one or more of water insoluble Zinc salt, complex or derivative thereof and an effective amount of one or more of water insoluble Iron salt, complex or derivative thereof with an effective amount of at least one agrochemically acceptable excipient.

The present invention further relates to a method of treating plants and meeting their nutritional requirement by making essential nutrients like Magnesium, Zinc and Iron available to them and also unlocking other micronutrients and trace elements present in the soil which hitherto were not available because of various factors primarily being soil degradation on account of excessive use of synthetic fertilizers. The present invention also relates to strengthening the plants so as to withstand pest infestation.

The present invention also relates to a method of biofortification of plant with essential micronutrients.

Further, the composition of present invention was found to be effective independent of the soil pH making it a viable composition for all types of soils. More importantly, it was noted that the presence of Magnesium along with Zinc and Iron in the form of composition of present invention facilitates not only the uptake of Iron and Zinc in the composition but also enabled the plant uptake of nutrients like Boron, Manganese, Calcium etc entrapped in the soil. The composition of the present invention was found to play a vital role in regulating soil pH and facilitating the uptake of nutrients even in soils which have been degraded or whose pH have been altered because of excessive use of synthetic fertilizers. It was further surprisingly observed that the composition of the present invention provides a balanced uptake of all nutrients including Zinc, Iron and Magnesium, thus overcoming the challenge of providing a nutrient rich crop in calcareous soils which is known to provide an antagonism challenge for the uptake of these nutrients. It was further surprising to observe that this results in a more balanced uptake of all nutrients, leading to a healthier plant, higher nutrient harvest in all types of soils and improving soil health. The present composition acts as a nutrient use efficient composition while meeting the need of crops by providing a multi nutritive solution with improved uptake by crops in a single application

On account of superior physical characteristics such as suspensibility, dispersibility and wettability exhibited, the composition of the present invention also finds a direct use in micro irrigation or drip irrigation systems.

### DESCRIPTION OF THE INVENTION

In describing the embodiment of the invention, specific terminology is chosen for the sake of clarity. However, it is not intended that the invention be limited to the specific terms so selected and it is to be understood that such specific terms include all technical equivalents that operate in a similar manner to accomplish a similar purpose. It is understood that any numerical range recited herein is intended to include all subranges subsumed. Also, unless denoted otherwise percentage of components in a composition are presented as weight percent.

The terms “a” or “an”, as used herein, are defined as one or more than one. The terms “including” and/or “having”, as used herein, are defined as comprising (i.e., open language).

The term “plant” or “crop” used in this application are interchangeable and wherever the term “plant” has been used shall also mean vegetations of similar nature namely crops, trees, shrub, herb etc.

Nutrient Use Efficiency (NUE) is defined as a measure of how well plants use the available mineral nutrients. Improvement of NUE is an essential pre-requisite for expansion of crop production into marginal lands with low nutrient availability but also a way to reduce use of inorganic fertilizer.

A water dispersible granule is defined as a formulation that disperses or dissolves readily when added to water to give a fine particle suspension. As described herein, “WG” or “WDG” refer to water dispersible granules. Water-dispersible granules are formulated as small, easily measured granules (an agglomeration of fine particles) by blending and agglomerating a ground solid active ingredient together with surfactants and other formulation ingredients which disperse into finer/primary particles when immersed in water. The water-dispersible granules are obtained by spray drying or by extrusion process.

A mixture is defined as a combination of two or more substances that are not chemically united to each other. A homogeneous mixture is defined as the one whose composition is uniform throughout the mixture. It is the type of mixture where the composition constant throughout or the components that make up the mixture are distributed uniformly.

The present invention relates to a composition for crop nutrition in the form of water dispersible granules comprising a homogeneous mixture of one or more of water insoluble Magnesium salt, complex or derivative thereof and one or more of water insoluble Zinc salt, complex or derivative thereof and one or more of water insoluble Iron salt, complex or derivative thereof with at least one agrochemically acceptable excipient.

The water dispersible granular composition of the present invention includes a homogeneous mixture of 1% to 50% by weight of one or more water insoluble Iron salt, complex or derivative thereof, 1% to 80% by weight of one or more water insoluble Magnesium salt, complexes or derivative thereof, 1% to 50% by weight of one or more water insoluble Zinc salt, complex or derivative thereof, and 0.01%-97% by weight of agrochemically acceptable excipient. Further, the said crop nutrition composition comprises granules in the size range of 0.05 mm-4.0 mm, which when added to water disperses into fine particles in the size range of 0.1 micron to 20 microns and exhibits improved dispersibility and suspensibility. According to an embodiment, the agrochemical excipient is surfactant.

The present inventors surprisingly found that the present composition in the form of water dispersible granules comprising Magnesium, Zinc and Iron together is not only effective but also synergistic. It was also noted by the present inventors that the application of the composition renders a greater and balanced uptake of not only Magnesium, Iron and Zinc but of other nutrients that remained entrapped in the soil and provide a natural biofortification solution in a sustainable manner, even in degraded soils.

It was observed that the surprising effect was noted when the present composition comprising a combination of water insoluble salts, complex or derivatives of Magnesium, Zinc and Iron in specific proportions was formulated into a water dispersible granular form along with a specific particle size distribution. The composition of the present invention was found to address the challenges of nutrient antagonism in the soil namely between Zinc and Iron, Magnesium and Zinc, Magnesium and Iron, etc. The present composition was further observed to prevent the leaching of these nutrients and make them available to the fullest extent for the uptake by crops and increase the overall yield.

According to an embodiment, the crop nutrition composition is in the form of water dispersible granules, wherein the granules are in the size range of 0.05 mm to 4.0 mm. According to further embodiment, the crop nutrition composition is in the form of water dispersible granules, wherein the granules are in the size range of 0.05 mm to 3.0 mm. Preferably, the crop nutrition composition is in the form of water dispersible granules, wherein the granules are in the size range of 0.05 mm to 2.5 mm. Preferably, the crop nutrition composition is in the form of water dispersible granules, wherein the granules are in the size range of 0.05 mm to 2 mm. Preferably, the crop nutrition composition is in the form of water dispersible granules, wherein the granules are in the size range of 0.05 mm to 1.5 mm. Preferably, the crop nutrition composition is in the form of water dispersible granules, wherein the granules are in the size range of 0.05 mm to 1 mm. More preferably, the crop nutrition composition is in the form of water dispersible granules, wherein the granules are in the size range of 0.05 mm to 0.5 mm.

According to an embodiment, the crop nutrition composition in the form of water dispersible granules when added to water disperses into particles in the size range of 0.1 micron to 20 microns, preferably into the particles in the size range of 0.1 micron to 15 microns. It was further observed that the present composition when formulated at a specific particle size of 0.1 micron to 20 microns, made the nutrients Magnesium, Zinc and Iron readily available for uptake by the plants and increase the overall yield. Thus, the particle size range of 0.1 micron to 20 microns of the crop nutrition composition was found to be important not only in terms of ease of application but also in terms of efficacy.

According to another embodiment, the crop nutrition composition of the present invention in the form of water dispersible granules comprises particles having diameter distribution of D90 of about 15 microns, more preferably, the water dispersible granules comprises particles having diameter distribution of D90 of about 10 microns.

According to an embodiment, the water dispersible granular crop nutrition composition is in the form of microgranules, wherein the granules disperses into the fine particles in the size range of 0.1 micron to 20 microns.

According to a further embodiment, the water-insoluble Iron salts include one or more of but not limited to Iron Oxide, Iron Hydroxide, Iron Phosphate, Iron Fumarate, Iron Succinate, Iron Tartrate, Iron Sulphide, Iron Oxalate, Carbonyl Iron, Iron Silicate, Iron Rust, Limonite, Iron Carbonate, complexes, derivative and mixtures, thereof. The Iron Oxide includes but not limited to, Ferrous Oxide (FeO), Ferric Oxide (Fe₂O₃) or Red Oxide, and Ferroso Ferric Oxide (Fe₃O₄) or Black Iron Oxide. Iron Hydroxide includes, but is not limited to, Ferric Hydroxide, Yellow Iron Oxide (FeOOH), Iron Hydroxide (Fe(OH)₃), Iron Hydroxide (III), Iron Oxyhydroxide and Limonite. Iron Phosphate includes but not limited to, Ferric Phosphate, Ferric Phosphate Dihydrate, Ferric Phosphate Hydrate, Ferrous Pyrophosphate. Iron Fumarate includes but not limited to Ferrous Fumarate and Ferro Fumarate. Iron Succinate includes but is not limited to Ferrous Succinate and Succinic Acid Iron (II) salt. However, those skilled in the art will appreciate that it is possible to utilize other water-insoluble Iron salt, complex or derivative thereof without departing from the scope of the invention.

According to an embodiment, the water insoluble Iron salt, complex or derivative thereof include one or more of Iron containing minerals selected from but not limited to Iron ores including one or more of Roaldite, Taenite, Wüstite, Magnetite, Hematite, Troilite, Goethite, Greigite, Limonite, Siderite, Pyrite (Marcasite), Bernalite, Greenalite. However, the above list of ores or minerals is exemplary and not meant to limit the scope of the invention.

According to an embodiment, the water insoluble Iron salt, complex, derivative or mixture thereof is present in the range of 1% to 50% by weight of the total composition. According to an embodiment, the water insoluble Iron salt, complex, derivative or mixture thereof is present in the range of 1% to 40% by weight of the total composition. According to an embodiment, the water insoluble Iron salt, complex, derivative or mixture thereof is present in the range of 1% to 30% by weight of the total composition. According to an embodiment, the water insoluble Iron salt, complex, derivative or mixture thereof is present in the range of 1% to 20% by weight of the total composition. According to an embodiment, the water insoluble Iron salt, complex, derivative or mixture thereof is present in the range of 1% to 10% by weight of the total composition. According to an embodiment, the water insoluble Iron salt, complex, derivative or mixture thereof is present in the range of 1% to 5% by weight of the total composition.

According to further embodiment, the water-insoluble Zinc salts include one or more of but not limited to Zinc Oxide, Zinc Carbonate, Zinc Sulphide, Zinc Molybdate, Zinc Phosphate, Zinc Nitrilotriacetic Acid (NTA), Zinc Borate, Zinc Silicate, Zinc Pyrophosphate, Zinc Citrate, complex or derivatives thereof. However, those skilled in the art will appreciate that it is possible to utilize other water insoluble Zinc salts, complexes or derivatives thereof without departing from the scope of the invention.

According to an embodiment, the water insoluble Zinc salt, complex or derivative thereof include one or more of Zinc containing minerals selected from but not limited to Zinc ores including one or more of Periclase, Danbaite, Ashoverite, Sphalerite, Wurtzite. However, the above list of ores or minerals is exemplary and not meant to limit the scope of the invention.

According to an embodiment, the water insoluble Zinc salt, complex, derivative or mixture thereof is present in the range of 1% to 50% by weight of the total composition. According to an embodiment, the water insoluble Zinc salt, complex, derivative or mixture thereof is present in the range of 1% to 40% by weight of the total composition. According to an embodiment, the water-insoluble Zinc salt, complex, derivative or mixtures thereof is present in the range of 1% to 30% by weight of the total composition. According to an embodiment, the water-insoluble Zinc salt, complex, derivative or mixture thereof is present in the range of 1% to 20% by weight of the total composition. According to an embodiment, the water-insoluble Zinc salt, complex, derivative or mixture thereof is present in the range of 1% to 10% by weight of the total composition. According to an embodiment, the water insoluble Zinc salt, complex, derivative or mixture thereof is present in the range of 1% to 5% by weight of the total composition.

According to a further embodiment, the water insoluble Magnesium salts include one or more of but not limited to Magnesium Molybdate, Magnesium Hydroxide (Milk of Magnesia), Calcium Magnesium Phosphate, Magnesium Phosphate Tribasic, Magnesium Carbonate, Magnesium Aluminium Silicate, Calcium Magnesium Silicate, Magnesium Trisilicate, Magnesium Phosphate, Magnesium Silicate, Magnesium Oxide, complex, derivative, thereof. However, those skilled in the art will appreciate that it is possible to utilize other water insoluble Magnesium salts, complexes, derivatives or mixtures thereof without departing from the scope of the invention.

According to an embodiment, the water insoluble Magnesium salts, complex or derivative thereof include one or more of Magnesium-containing minerals selected from but not limited to Magnesium ores including one or more of Periclase, Brucite, Sellaite, Kotoite, Pertsevite, Suanite, Magnesite, Szaibélyite, Neighborite. However, the above list of ores or minerals is exemplary and not meant to limit the scope of the invention.

According to an embodiment, the water insoluble Magnesium salt, complex, derivative or mixture thereof is present in the range of 1% to 80% by weight of the total composition. According to an embodiment, the water insoluble Magnesium salt, complex, derivative or mixture thereof is present in the range of 1% to 70% by weight of the total composition. According to an embodiment, the water insoluble Magnesium salt, complex, derivative or mixture thereof is present in the range of 1% to 60% by weight of the total composition. According to an embodiment, the water insoluble Magnesium salt, complex, derivative or mixture thereof is present in the range of 1% to 50% by weight of the total composition. According to an embodiment, the water insoluble Magnesium salt, complex, derivative or mixture thereof is present in the range of 1% to 40% by weight of the total composition. According to an embodiment, the water insoluble Magnesium salt, complex, derivative or mixture thereof is present in the range of 1% to 30% by weight of the total composition. According to an embodiment, the water insoluble Magnesium salt, complex, derivative or mixture thereof is present in the range of 1% to 20% by weight of the total composition. According to an embodiment, the water insoluble Magnesium salt, complex, derivative or mixture thereof is present in the range of 1% to 10% by weight of the total composition.

According to another embodiment, the crop nutrition composition in the form of water dispersible granules comprises a homogeneous mixture of one or more of water insoluble Magnesium salt, complex or derivative thereof in the range of 1% to 80% by weight of the total composition and one or more of water insoluble Zinc salt, complex or derivative thereof in the range of 1% to 50% by weight of the total composition and one or more of water insoluble Iron salt, complex or derivative thereof in the range of 1% to 50% by weight of the total composition and one or more surfactant in the range of 1% to 40% by weight of the total composition.

According to an embodiment, the crop nutrition composition in the form of water dispersible granules comprises a homogeneous mixture of one or more of Magnesium Oxide or Magnesium Silicate or Magnesium Carbonate or Magnesium Phosphate or Magnesium Hydroxide in the range of 1% to 80% by weight of the total composition and one or more of Zinc Oxide or Zinc Carbonate or Zinc Silicate or Zinc Hydroxide or Zinc Phosphate in the range of 1% to 50% by weight of the total composition and one or more of Iron Oxide or Iron Carbonate or Iron Hydroxide or Iron Silicate or Iron Phosphate in the range of 1% to 50% by weight of the total composition with one or more agrochemically acceptable excipient in the range of 0.01% to 97% by weight of the total composition; wherein the composition comprises granules in the size range of 0.05-4.0 mm and is having particles in the size range of 0.1 micron to 20 microns.

According to an embodiment, the crop nutrition composition in the form of water dispersible granules comprises a homogeneous mixture of one or more of Magnesium Oxide or Magnesium Silicate or Magnesium Carbonate or Magnesium Phosphate or Magnesium Hydroxide in the range of 1% to 80% by weight of the total composition and one or more of Zinc Oxide or Zinc Carbonate or Zinc Silicate or Zinc Hydroxide or Zinc Phosphate in the range of 1% to 50% by weight of the total composition and one or more of Iron Oxide or Iron Carbonate or Iron Hydroxide or Iron Silicate or Iron Phosphate in the range of 1% to 50% by weight of the total composition with one or more surfactant in the range of 1% to 40% by weight of the total composition, wherein the composition comprises granules in the size range of 0.05-4.0 mm and is having particle in the size range of 0.1 micron to 20 microns.

According to an embodiment, the crop nutrition composition may further comprise at least one additional water insoluble plant nutrient.

According to an embodiment, the additional water insoluble plant nutrient is present in the range of from 0.01% to 40% by weight of the total composition.

According to an embodiment, the crop nutrition composition is devoid of fertilizers that primarily comprise of alginic acid or urea.

According to an embodiment, the crop nutrition composition in the form of water dispersible granules comprises at least one agrochemical excipient. According to further embodiment, the agrochemically acceptable excipients which are used in water dispersible granular formulation include at least one wetting agent, surfactant, emulsifier, dispersing agent, binder or filler or carrier or diluent, disintegrating agent, buffer or pH adjuster or neutralizing agent, antifoaming agent, anti-settling agent, anticaking agent, penetrating agent, sticking agent, tackifier, pigment, colorant, stabilizer and mixtures thereof. According to an embodiment, the surfactants include one or more of anionic, cationic, non-ionic, amphoteric and polymeric surfactants. According to an embodiment, the surfactants include one or more of emulsifiers, wetting agents and dispersing agents. However, those skilled in the art will appreciate that it is possible to utilize additional agrochemically acceptable excipients without departing from the scope of the present invention. The agrochemically acceptable excipients are commercially manufactured and available through various companies.

According to an embodiment, the agrochemical excipients are present in a concentration range of 0.01% to 97% by weight of the total composition. According to an embodiment, the agrochemical excipients are present in a concentration range of at least 96% by weight of the total composition. According to an embodiment, the agrochemical excipients are present in a concentration range of at least 95% by weight of the total composition. According to an embodiment, the agrochemical excipients are present in a concentration range of at least 90% by weight of the total composition. According to an embodiment, the agrochemical excipients are present in a concentration range of at least 75% by weight of the total composition. According to an embodiment, the agrochemical excipients are present in a concentration range of at least 55% by weight of the total composition. According to an embodiment, the agrochemical excipients are present in a concentration range of at least 35% by weight of the total composition. According to an embodiment, the agrochemical excipients are present in a concentration range of at least 25% by weight of the total composition. According to an embodiment, the agrochemical excipients are present in a concentration range of at least 15% by weight of the total composition. According to an embodiment, the agrochemical excipients are present in a concentration range of at least 5% by weight of the total composition. According to an embodiment, the agrochemical excipients are present in a concentration range of at least 1% by weight of the total composition. According to an embodiment, the agrochemical excipients are present in a concentration range of at least 0.1% by weight of the total composition

According to an embodiment, the surfactants which are used in the crop nutrition composition include one or more of emulsifiers, wetting agents and dispersing agents. According to an embodiment, the surfactants which are used in the composition include one or more of anionic, cationic, non-ionic, amphoteric and polymeric surfactants.

The anionic surfactants include one or more of, but not limited to a salt of Fatty Acid, a Benzoate, a Polycarboxylate, a salt of Alkylsulfuric Acid Ester, Alkyl Ether Sulfates, an Alkyl Sulfate, an Alkylarylsulfate, an Alkyl Diglycol Ether Sulfate, a Salt of Alcohol Sulfuric Acid Ester, an Alkyl Sulfonate, an Alkylaryl Sulfonate, an Aryl Sulfonate, a Lignin Sulfonate, an Alkyl Diphenyl Ether Disulfonate, a Polystyrene Sulfonate, a Salt Of Alkylphosphoric Acid Ester, an Alkylaryl Phosphate, a Styrylaryl Phosphate, Sulfonate Docusates, a Salt Of Polyoxyethylene Alkyl Ether Sulfuric Acid Ester, a Polyoxyethylenealkylaryl Ether Sulfate, Alkyl Sarcosinates, Alpha Olefin Sulfonate Sodium Salt, Alkyl Benzene Sulfonate or Its Salts, Sodium Lauroylsarcosinate, Sulfosuccinates, Polyacrylates, Polyacrylates—Free Acid and Sodium Salt, Salt of Polyoxyethylenealkylaryl Ether Sulfuric Acid Ester, a Polyoxyethylene Alkyl Ether Phosphate, a Salt of Polyoxyethylenealkylaryl Phosphoric Acid Ester, Sulfosuccinates—Mono and other Diesters, Phosphate Esters, Alkyl Naphthalene Sulfonate-Isopropyl and Butyl Derivatives, Alkyl Ether Sulfates-Sodium And Ammonium Salts; Alkyl Aryl Ether Phosphates, Ethylene Oxides and Its Derivatives, a salt of Polyoxyethylene Aryl Ether Phosphoric Acid Ester, Mono-Alkyl Sulphosuccinates, Aromatic Hydrocarbon Sulphonates, 2-Acrylamido-2-Methylpropane Sulfonic Acid, Ammonium Laurylsulphate, Docusate, Disodium Cocoamphodiacetate, Magnesium Laurethsulfate, Phospholipid, Potassium Lauryl Sulfate, Soap, Soap Substitute, Sodium Alkyl Sulfate, Sodium Dodecyl Sulfate, Sodium Dodecylbenzenesulfonate, Sodium Laurate, Sodium Laurethsulfate, Sodium Lauroylsarcosinate, Sodium Myrethsulfate, Sodium Nonanoyloxybenzenesulfonate, Alkyl Carboxylates, Sodium Stearate, Alpha Olefin Sulphonates, Naphthalene Sulfonate Salts, Alkyl Naphthalene Sulfonate Fatty Acid salts, Naphthalene Sulfonate Condensates-Sodium salt, Fluoro Carboxylate, Fatty Alcohol Sulphates, Alkyl Naphthalene Sulfonate Condensates—Sodium Salt, A Naphthalene Sulfonic Acid Condensed with Formaldehyde or a Salt of Alkylnaphthalene Sulfonic Acid condensed with Formaldehyde, or salts, derivatives thereof.

The non-ionic surfactants include one or more of but not limited to Polyol Esters, Polyol Fatty Acid Esters, Polyethoxylated Esters, Polyethoxylated Alcohols, Ethoxylated and Propoxylated Fatty Alcohols, Ethoxylated and Propoxylated Alcohols, Ethylene Oxide (EO)/Propylene Oxide (PO) Copolymers; EO and PO Block Copolymers, Di, Tri-Block Copolymers; Block Copolymers Of Polyethylene Glycol and Polypropylene Glycol, Poloxamers, Polysorbates, Alkyl Polysaccharides such as Alkyl Polyglycosidesand Blends thereof, Amine Ethoxylates, Sorbitan Fatty Acid Ester, Glycol and Glycerol Esters, Glucosidyl Alkyl Ethers, Sodium Tallowate, Polyoxyethylene Glycol, Sorbitan Alkyl Esters, Sorbitan Derivatives, Fatty Acid Esters of Sorbitan (Spans) and Their Ethoxylated Derivatives (Tweens), and Sucrose Esters of Fatty Acids, Cocamide Diethanolamine (DEA), Cocamide Monoethanolamine (MEA), Decyl Glucoside, Decylpolyglucose, Glycerol Monostearate, Lauryl Glucoside, Maltosides, Monolaurin, Narrow-Range Ethoxylate, Nonidet P-40, Nonoxynol-9, Nonoxynols, Octaethylene Glycol Monododecyl Ether, N-Octyl Beta-D-Thioglucopyranoside, Octyl Glucoside, Oleyl Alcohol, PEG-10 Sunflower Glycerides, Pentaethylene Glycol Monododecyl Ether, Polidocanol, Poloxamer, Poloxamer 407, Polyethoxylated Tallow Amine, Polyglycerol Polyricinoleate, Polysorbate, Polysorbate 20, Polysorbate 80, Sorbitan, Sorbitanmonolaurate, Sorbitanmonostearate, Sorbitantristearate, Stearyl Alcohol, Surfactin, Glyceryl Laureate, Lauryl Glucoside, Nonylphenolpolyethoxyethanols, Nonyl Phenol Polyglycol Ether, Castor Oil Ethoxylate, Polyglycol Ethers, Polyadducts of Ethylene Oxide and Propylene Oxide, Block Copolymer of Polyalkylene Glycol Ether and Hydroxystearic Acid, Tributylphenoxypolyethoxy Ethanol, Octylphenoxypolyethoxy Ethanol, Etho-Propoxylatedtristyrlphenols, Ethoxylated Alcohols, Polyoxy Ethylene Sorbitan, Fatty Acid Polyglyceride, a Fatty Acid Alcohol Polyglycol Ether, Acetylene Glycol, Acetylene Alcohol, an Oxyalkylene Block Polymer, Polyoxyethylene Alkyl Ether, Polyoxyethylenealkylaryl Ether, a Polyoxyethylenestyrylaryl Ether, a Polyoxyethylene Glycol Alkyl Ether, Polyethylene Glycol, a Polyoxyethylene Fatty Acid Ester, a Polyoxyethylenesorbitan Fatty Acid Ester, a Polyoxyethyleneglycerin Fatty Acid Ester, Alcohol Ethoxylates—C6 to C16/18 Alcohols, Linear and Branched, Alcohol Alkoxylates-Various Hydrophobes and EO/PO Contents and Ratios, Fatty Acid Esters-Mono and Diesters, Lauric, Stearic and Oleic, Glycerol Esters—with and without EO, Lauric, Stearic, Cocoa and Tall Oil Derived, Ethoxylated Glycerine, Sorbitan Esters—with and without EO; Lauric, Stearic and Oleic Based, Mono and Trimesters, Castor Oil Ethoxylates-5 to 200 Moles EO, Non-Hydrogenated and Hydrogenated, Block Polymers, Amine Oxides—Ethoxylated and Non-Ethoxylated; Alkyl Dimethyl, Fatty Amine Ethoxylates—Coco, Tallow, Stearyl, Oleyl Amines, a Polyoxyethylene Hydrogenated Castor Oil or a Polyoxypropylene Fatty Acid Ester, salts or derivatives thereof.

Amphoteric or Zwitterionic surfactants include one or more of, but not limited to one or more of Betaine, Coco and Lauryl Amidopropyl Betaines, Coco Alkyl Dimethyl Amine Oxides, Alkyl Dimethyl Betaines; C8 to C18, Alkyl Dipropionates—Sodium Lauriminodipropionate, Cocoamidopropyl Hydroxyl Sulfobetaine, Imidazolines, Phospholipids Phosphatidylserine, Phosphatidylethanolamine, Phosphatidylcholine and Sphingomyelins, Lauryl Dimethylamine Oxide, Alkyl Amphoacetates and Proprionates, Alkyl Ampho(Di)Acetates and Di-Proprionates, Lecithin and Ethanolamine Fatty Amides or salts, derivatives thereof.

Surfactants that are commercially available under the trademark but are not limited to one or more of Atlas G5000, TERMUL 5429, TERMUL 2510, ECOTERIC®, EULSOGEN® 118, Genapol®X, Genapol®OX-080, Genapol® C 100, Emulsogen® EL 200, Arlacel P135, Hypermer 8261, Hypermer B239, Hypermer B261, Hypermer B246sf, Solutol HS 15, Promulgen™ D, Soprophor 7961P, Soprophor TSP/461, Soprophor TSP/724, Croduret 40, Etocas 200, Etocas 29, Rokacet R26, Cetomacrogol 1000, CHEMONIC OE-20, Triton N-101, Triton X-100, Tween 20, 40, 60, 65, 80, Span20, 40, 60, 80, 83, 85, 120, Brij®, Atlox 4912, Atlas G5000, TERMUL 3512, TERMUL 3015, ECOTERIC® T85, ECOTERIC® T20, TERIC 12A4,] IGEPAL CA-630 and Isoceteth-20.

However, those skilled in the art will appreciate that it is possible to utilize other conventionally known surfactants without departing from the scope of the present invention. The surfactants are commercially manufactured and available through various companies.

According to an embodiment, the surfactant is present in an amount of 0.1% to 40% w/w of the total composition. According to an embodiment; the surfactant is present in an amount of 0.1% to 30% w/w of the total composition. According to further embodiment, the surfactant is present in an amount of 0.1% to 20% w/w of the total composition. According to further embodiment, the surfactant is present in an amount of 0.1% to 10% w/w of the total composition.

According to an embodiment, the dispersing agents which are used in the crop nutrition composition includes, but not limited to one or more of polyvinyl pyrrolidone, polyvinyl alcohol, lignin sulphonates, phenol naphthalene sulphonates, alkali metal, alkaline earth metal and ammonium salts of lignosulfonic acid, lignin derivatives, dibutylnaphthalene-sulfonic acid, alkylarylsulfonates, alkyl sulfates, alkylsulfonates, fatty alcohol sulfates, fatty acids and sulfated fatty alcohol glycol ethers, polyoxyethylene alkyl ethers, dioctyl sulfosuccinate, lauryl sulfate, polyoxyethylene alkyl ether sulphate, polyoxyethylenestyryl phenyl ether sulfate ester salts and the like, alkali metal salts thereof, ammonium salts or amine salts, polyoxyethylene alkyl phenyl ether, polyoxyethylenestyryl phenyl ether, polyoxyethylene alkyl esters, or polyoxyethylenesorbitan alkyl esters, and the like, mixture of sodium salt of naphthalene sulphonic acid urea formaldehyde condensate and sodium salt of phenol sulphonic formaldehyde condensate ethoxylated alkyl phenols, ethoxylated fatty acids, alkoxylated linear alcohols, polyaromatic sulfonates, sodium alkyl aryl sulfonates, glyceryl esters, ammonium salts of maleic anhydride copolymers, maleic anhydride copolymers, phosphate esters, condensation products of aryl sulphonic acids and formaldehyde, addition products of ethylene oxide and fatty acid esters, salts of addition products of ethylene oxide and fatty acid esters, sodium salt of isodecylsulfosuccinic acid half ester, polycarboxylates, sodium alkyl benzene sulfonates, sodium salts of sulfonated naphthalene, ammonium salts of sulfonated naphthalene, salts of polyacrylic acids, sodium salts of condensed phenolsulfonic acid as well as the naphthalene sulfonate-formaldehyde condensates, sodium naphthalene sulfonate formaldehyde condensates, tristyrylphenolethoxylate phosphate esters, aliphatic alcohol ethoxylates, alkyl fatty acids, alkoxylated linear alcohols, polyaromatic sulfonates, sodium alkyl aryl sulfonates, glyceryl esters, ammonium salts of maleic anhydride copolymers, maleic anhydride copolymers, phosphate esters, condensation products of aryl sulphonic acids and formaldehyde, addition products of ethylene oxide and fatty acid esters, salts of addition products of ethylene oxide and fatty acid esters, sodium salt of isodecylsulfosuccinic acid half ester, polycarboxylates, sodium alkyl benzene sulfonates, sodium salts of sulfonated naphthalene, ammonium salts of sulfonated naphthalene, salts of polyacrylic acids, sodium salts of condensed phenolsulfonic acid as well as the naphthalene sulfonate formaldehyde condensates, sodium naphthalene sulfonate formaldehyde condensates, tristyrylphenolethoxylate phosphate esters, aliphatic alcohol ethoxylates, alkyl ethoxylates, EO-PO block copolymers, graft copolymers, ammonium salts of sulfonated naphthalene, salts of polyacrylic acids, salts, derivatives thereof.

Commercially available dispersing agents include “Morwet D425” (sodium naphthalene formaldehyde condensate ex Nouryon, USA), “Morwet EFW” Sulfated Alkyl Carboxylate and Alkyl Naphthalene Sulfonate—Sodium Salt, “Tamol PP” (sodium salt of a phenolsulphonic acid condensate), “Reax 80N” (sodium lignosulphonate), “Wettol D1” sodium alkylnaphthalene sulphonate (ex BASF). However, those skilled in the art will appreciate that it is possible to utilize other conventionally known dispersants without departing from the scope of the present invention. The dispersing agents are commercially manufactured and available through various companies.

According to an embodiment, the dispersing agent is present in an amount of 0.1%-40% w/w of the total composition. According to an embodiment, the dispersing agent is present in an amount of 0.1%-30% w/w of the total composition. According to an embodiment, the dispersing agent is present in an amount of 0.1%-20% w/w of the total composition.

According to an embodiment the wetting agents used in the crop nutrition composition include, but not limited to one or more of phenol naphthalene sulphonates, alkyl naphthalene sulfonate, sodium alkyl naphthalene sulfonate, naphthalene sulphonate sodium salt, sodium salt of sulfonated alkylcarboxylate, polyoxyalkylated ethyl phenols, polyoxyethoxylated fatty alcohols, polyoxyethoxylated fatty amines, lignin derivatives, alkane sulfonates, alkylbenzene sulfonates, salts of polycarboxylic acids, salts of esters of sulfosuccinic acid, alkylpolyglycol ether sulfonates, alkyl ether phosphates, alkyl ether sulphates and alkyl sulfosuccinic monoesters, salts, derivatives thereof. However, those skilled in the art will appreciate that it is possible to utilize other conventionally known wetting agents without departing from the scope of the present invention. The wetting agents are commercially manufactured and available through various companies.

According to an embodiment, the wetting agent is present in an amount of 0.1%-30% w/w of the total composition. According to an embodiment, the wetting agent is present in an amount of 0.1%-20% w/w of the total composition. According to an embodiment, the wetting agent is present in an amount of 0.1%-10% w/w of the total composition.

Emulsifiers which are used in the crop nutrition composition include but are not limited one or more of Atlas G5000, TERMUL 5429, TERMUL 2510, ECOTERIC®, EMULSOGEN® 118, Genapol®X, Genapol®OX-080, Genapol® C 100, Emulsogen® EL 200, Arlacel P135, Hypermer 8261, Hypermer B239, Hypermer B261, Hypermer B246sf, Solutol HS 15, Promulgen™ D, Soprophor 7961P, Soprophor TSP/461, Soprophor TSP/724, Croduret 40, Etocas 200, Etocas 29, Rokacet R26, CHEMONIC OE-20, Triton™ N-101, Tween 20, 40, 60, 65, 80, Span20, 40, 60, 80, 83, 85, 120, Brij®, Triton™, Atlox 4912, TERMUL 3512, TERMUL 3015, TERMUL 5429, TERMUL 2510, ECOTERIC® T85, ECOTERIC® T20, TERIC 12A4. However, those skilled in the art will appreciate that it is possible to utilize other conventionally known emulsifiers without departing from the scope of the present invention. The emulsifiers are commercially manufactured and available through various companies.

According to an embodiment, the emulsifier is present in an amount of 0.1%-40% w/w of the total composition. According to an embodiment, the emulsifier is present in an amount of 0.1%-30% w/w of the total composition. According to an embodiment, the emulsifier is present in an amount of 0.1%-20% w/w of the total composition.

According to an embodiment, the disintegrating agents which are used in the crop nutrition composition include, but not limited to one or more of inorganic water soluble salts e.g. sodium chloride, nitrate salts; water soluble organic compounds such as hydroxypropyl starch, carboxymethyl starch ether, microcrystalline cellulose, cross-linked sodium carboxymethyl cellulose, carboxymethyl cellulose calcium, sodium tripolyphosphate, sodium hexametaphosphate, a cellulose powder, dextrin, methacrylate copolymer, Polyplasdone® XL-10 (crosslinked polyvinylpyrrolidone), sulfonated styrene-isobutylene-maleic anhydride copolymer, salts of polyacrylates of methacrylates, starch-polyacrylonitrile graft copolymer, sodium or potassium bicarbonates/carbonates or their mixtures or salts with acids such as citric and fumaric acid or salts, derivatives thereof. However, those skilled in the art will appreciate that it is possible to utilize different disintegrating agents without departing from the scope of the present invention. The disintegrating agents are commercially manufactured and available through various companies.

According to an embodiment, the disintegrating agent is present in an amount of 0.1% to 20% w/w of the composition. According to an embodiment, the disintegrating agent is present in an amount of 0.1% to 10% w/w of the composition. According to an embodiment, the disintegrating agent is present in an amount of 0.1% to 5% w/w of the composition.

According to an embodiment, the binding agents or binders which are used in the crop nutrition composition include, but not limited to one or more of carbohydrates such as monosaccharides, disaccharides, oligosaccharides and polysaccharides, complex organic substance, lignin sulfonates, polyvinylpyrrolidone, synthetic organic polymers or derivatives and combinations thereof. However, those skilled in the art will appreciate that it is possible to utilize different binding agents without departing from the scope of the present invention. The binding agents are commercially manufactured and available through various companies.

According to further embodiment, the binding agent is present in an amount of 0.1% to 30% w/w of the composition. According to further embodiment, the binding agent is present in an amount of 0.1% to 20% w/w of the composition.

According to further embodiment, the binding agent is present in an amount of 0.1% to 10% w/w of the composition.

According to an embodiment, the carriers which are used in the crop nutrition composition include, but are not limited to one or more of solid carriers or fillers or diluents. According to another embodiment, the carriers include mineral carriers, plant carriers, synthetic carriers, water-soluble carriers. However, those skilled in the art will appreciate that it is possible to utilize different carriers without departing from the scope of the present invention. The carriers are commercially manufactured and available through various companies.

The solid carriers include natural minerals like clay such as china clay, acid clay, kaolin such as kaolinite, dickite, nacrite, and halloysite, serpentines such as chrysotile, lizardite, antigorite, amesite, synthetic and diatomaceous silicas, montmorillonite minerals such as sodium montmorillonite, smectites, such as saponite, hectorite, sauconite, hyderite, micas, such as pyrophyllite, talc, agalmatolite, muscovite, phengite, sericite, and illite, silicas such as cristobalite and quartz, such as attapulgite and sepiolite, vermiculite, laponite, pumice, bauxite, hydrated aluminas, perlite, sodium bicarbonate, volclay, limestone, natural and synthetic silicates, charcoal, silicas, wet process silicas, dry process silicas, calcined products of wet process silicas, surface-modified silicas, mica, zeolite, diatomaceous earth, derivatives thereof, chalks (Omya®), fuller's earth, loess, mirabilite, white carbon, slaked lime, synthetic silicic acid, starch, modified starch (Pineflow, available from Matsutani Chemical industry Co., Ltd.), cellulose, plant carriers such as cellulose, chaff, wheat flour, wood flour, starch, rice bran, wheat bran, and soyabean flour, casein sodium, sucrose, salt cake, potassium pyrophosphate, sodium tripolyphosphate or derivatives or mixtures thereof. Commercially available Silicates are Aerosil brands, Sipernat brands as Sipernat® 50S and CALFLO E and kaolin 1777. However, those skilled in the art will appreciate that it is possible to utilize different solid carriers without departing from the scope of the present invention. The solid carriers are commercially manufactured and available through various companies.

According to an embodiment, the carrier is present in an amount of 0.1% to 97% w/w of the composition. According to further embodiment, the carrier is present in an amount of 0.1% to 80% w/w of the composition. According to further embodiment, the carrier is present in an amount of 0.1% to 60% w/w of the composition. According to further embodiment, the carrier is present in an amount of 0.1% to 40% w/w of the composition. According to further embodiment, the carrier is present in an amount of 0.1% to 20% w/w of the composition.

According to an embodiment, the antifoaming agents or defoamers which are used in the crop nutrition composition include, but not limited to one or more of silica, siloxane, silicone dioxide, polydimethyl siloxane, alkyl polyacrylates, ethylene oxide/propylene oxide copolymers, polyethylene glycol, silicone oils and magnesium stearate or derivatives thereof. Preferred antifoaming agents include silicone emulsions (such as, e.g., Silikon® SRE, Wacker or Rhodorsil® from Rhodia), long-chain alcohols, fatty acids, fluoro-organic compounds. However, those skilled in the art will appreciate that it is possible to utilize other conventionally known antifoaming agents without departing from the scope of the present invention. The antifoaming agents are commercially manufactured and available through various companies.

According to an embodiment, the anti-foaming agent is present in an amount of 0.01% to 20% w/w of the total composition.

According to an embodiment, the pH-adjusters or buffers or neutralizing agents which are used in the composition include both acids and bases of the organic or inorganic type and mixtures thereof. According to further embodiment, pH-adjusters or buffers or neutralizing agents include, but not limited to one or more of organic acids, inorganic acids and alkali metal compounds or salts, derivatives thereof. According to an embodiment, the organic acids include, but not limited to one or more of citric, malic, adipic, fumaric, maleic, succinic, and tartaric acid, or salts, derivatives thereof, and the mono-, di-, or tribasic salts of these acids or derivatives thereof. Alkali metal compounds include, but not limited to one or more of hydroxides of alkali metals such as sodium hydroxide and potassium hydroxide, carbonates of alkali metals such as sodium carbonate, hydrogen carbonates of alkali metals such as sodium hydrogen carbonate and alkali metal phosphates such as sodium phosphate and mixtures thereof. According to an embodiment, the salts of inorganic acids include, but not limited to one or more of alkali metal salts such as, sodium chloride, potassium chloride, sodium nitrate, potassium nitrate, sodium sulfate, potassium sulfate, sodium monohydrogen phosphate, potassium monohydrogen phosphate, sodium dihydrogen phosphate, potassium dihydrogen phosphate and the like. Mixtures can also be used to create a pH-adjusters or buffers or neutralizing agents. However, those skilled in the art will appreciate that it is possible to utilize other conventionally known pH-adjusters or buffers or neutralizing agents without departing from the scope of the present invention. The pH-adjusters or buffers or neutralizing agents are commercially manufactured and available through various companies.

According to an embodiment, the pH-adjusters or buffers are present in an amount of 0.01% to 20% w/w of the total composition. According to an embodiment, the pH-adjusters or buffers are present in an amount of 0.01% to 10% w/w of the total composition. According to an embodiment, the pH-adjusters or buffers are present in an amount of 0.01% to 5% w/w of the total composition. According to an embodiment, the pH-adjusters or buffers are present in an amount of 0.01% to 1% w/w of the total composition.

According to an embodiment, the spreading agents which are used in the composition include, but not limited to one or more of a copolymer of maleic acid with a styrene compound, a (meth)acrylic acid copolymer, a half ester of a polymer consisting of polyhydric alcohol with dicarboxylic anhydride, a water-soluble salt of polystyrene sulfonic acid, fatty acids, latex, aliphatic alcohols, vegetable oils such as cottonseed or inorganic oils, petroleum distillates, modified trisiloxanes, polyglycol or salts or derivatives thereof. However, those skilled in the art will appreciate that it is possible to utilize other conventionally known spreading agents without departing from the scope of the present invention. The spreading agents are commercially manufactured and available through various companies.

According to an embodiment, the spreading agent is present in an amount of 0.01% to 20% w/w of the total composition. According to an embodiment, the spreading agent is present in an amount of 0.01% to 5% w/w of the total composition.

According to an embodiment, the sticking agents which are used in the composition include, but not limited to one or more of paraffin, a polyamide resin, polyacrylate, polyoxyethylene, wax, polyvinyl alkyl ether, an alkylphenol-formalin condensate, fatty acids, latex, polyvinyl pyrrolidone, aliphatic alcohols, gums such as xanthan gum, gum ghati, gum arabic etc, vegetable oils such as cottonseed, or inorganic oils, petroleum distillates, modified trisiloxanes, polyglycol, a synthetic resin emulsion or salts or derivatives thereof. However, those skilled in the art will appreciate that it is possible to utilize other conventionally known sticking agents without departing from the scope of the present invention. The sticking agents are commercially manufactured and available through various companies.

According to an embodiment, the sticking agent is present in an amount of 0.01% to 30% w/w of the total composition. According to an embodiment, the sticking agent is present in an amount of 0.01% to 15% w/w of the total composition.

The inventors have further determined that the composition of the present invention surprisingly has enhanced physical properties of dispersibility, suspensibility, wetting time, provides ease of handling and also reduces the loss of material while handling the product at the time of packaging as well as during field application.

Wettability is the condition or the state of being wettable and can be defined as the degree to which a solid is wetted by a liquid, measured by the force of adhesion between the solid and liquid phases. The wettability of the granular composition is measured using the Standard CIPAC Test MT-53 which describes a procedure for the determination of the time of complete wetting of wettable formulations. A weighed amount of the granular composition is dropped on water in a beaker from a specified height and the time for complete wetting was determined.

According to an embodiment, the composition of the present invention has wettability of less than 2 minutes. According to an embodiment, the composition has wettability of less than 1 minute. According to an embodiment, the composition has wettability of less than 30 seconds.

Dispersibility of the water dispersible granular composition of the present application is determined as per the standard CIPAC test, MT 174. According to an embodiment, the water dispersible granular composition has a dispersibility of at least 30%. According to an embodiment, the water dispersible granular composition has a dispersibility of at least 40%. According to an embodiment, the water dispersible granular composition has a dispersibility of at least 50%. According to an embodiment, the water dispersible granular composition has can dispersibility of at least 60%. According to an embodiment, the water dispersible granular composition has a dispersibility of at least 70%. According to an embodiment, the water dispersible granular composition has a dispersibility of at least 80%. According to an embodiment, the water dispersible granular composition has a dispersibility of at least 90%. According to an embodiment, the water dispersible granular composition has a dispersibility of at least 99%.

According to an embodiment, the water dispersible granular composition has a dispersibility of 100%.

According to an embodiment, the crop nutrition composition in the form of water dispersible granules exhibits almost instantaneous dispersion thus making the actives readily available to the crops.

Suspensibility is defined as the amount of active ingredient suspended after a given time in a column of liquid of stated height, expressed as a percentage of the amount of active ingredient in the original suspension. The test for suspensibility is done as per the CIPAC Handbook, “MT 184 Test for Suspensibility”.

According to an embodiment, the composition of the present invention has a suspensibility of at least 30%. According to an embodiment, the composition has a suspensibility of at least 40%. According to an embodiment, the composition has a suspensibility of at least 50%. According to an embodiment, the composition has a suspensibility of at least 60%. According to an embodiment, the composition has a suspensibility of at least 70%. According to an embodiment, the composition has a suspensibility of at least 80%. According to an embodiment, the composition has a suspensibility of at least 90%. According to an embodiment, the composition has a suspensibility of at least 99%. According to an embodiment, the pesticidal composition has a suspensibility of 100%.

According to an embodiment, the composition of the present invention demonstrates superior suspensibility under accelerated storage condition (ATS). According to an embodiment, the composition demonstrates a suspensibility of more than 90% under ATS. According to an embodiment, the composition demonstrates a suspensibility of more than 80% under ATS. According to an embodiment, the composition demonstrates a suspensibility of more than 70% under ATS. According to an embodiment, the composition demonstrates a suspensibility of more than 60% under ATS. According to an embodiment, the composition demonstrates a suspensibility of more than 50% under ATS. According to an embodiment, the composition demonstrates a suspensibility of more than 40% under ATS. According to an embodiment, the composition demonstrates a suspensibility of more than 30% under ATS.

According to an embodiment, the composition of the present invention demonstrates a dispersibility of more than 90% under ATS. According to an embodiment, the composition demonstrates a dispersibility of more than 80% under ATS. According to an embodiment, the composition demonstrates a dispersibility of more than 70% under ATS. According to an embodiment, the composition demonstrates a dispersibility of more than 60% under ATS. According to an embodiment, the composition demonstrates a dispersibility of more than 50% under ATS. According to an embodiment, the composition demonstrates a dispersibility of more than 40% under ATS. According to an embodiment, the composition demonstrates a dispersibility of more than 30% under ATS.

According to an embodiment, the present invention relates to a process for preparing a crop nutrition composition in the form of water dispersible granules comprising a homogeneous mixture of an effective amount of one or more of water insoluble Magnesium salt, complex or derivative thereof and an effective amount of one or more of water insoluble Zinc salt, complex or derivative thereof and an effective amount of one or more of water insoluble Iron salt, complex or derivative thereof with at least one agrochemically acceptable excipient.

According to further embodiment, the invention relates to a process for preparing a crop nutrition composition in the form of water dispersible granular composition comprising a homogeneous mixture of one or more of water insoluble Magnesium salt, complex, or derivative thereof in the range of 1%-80% w/w of the total composition and one or more of water insoluble Zinc salt, complex or derivative thereof in the range of 1%-50% w/w of the total composition and one or more of water insoluble Iron salt, complex or derivative thereof in the range of 1%-50% w/w of the total composition with at least one agrochemically acceptable excipient in the range of 0.01%-97% w/w of the total composition; wherein the granules of the composition are in the size range of 0.05 mm-4.0 mm and comprises of fine particles in the size range of 0.1 micron-20 microns.

The crop nutrition composition in the form of water dispersible granules is made by various techniques such as spray drying, fluidized bed granulation, extrusion, freeze drying, spheronization etc.

According to an embodiment, the process of preparing a water dispersible granular composition involves milling a homogeneous blend of one or more of water insoluble Iron salt, complex or derivative thereof and one or more of water insoluble Zinc salt, complex or derivative thereof and one or more water insoluble Magnesium salt, complex or derivative thereof with at least one agrochemically acceptable excipient; to obtain slurry or a wet mix in water. The composition further includes at least one additional water insoluble plant nutrient. The wet mix obtained is then dried for instance in a spray dryer, fluid bed dryer or any suitable granulating equipment, followed by sieving to remove the under sized and oversized granules to obtain water dispersible granules in the size range of 0.05 mm-4.0 mm.

According to another embodiment, the crop nutrition composition in the form of water dispersible granules is also made by dry milling one or more of water insoluble Iron salt, complex or derivative thereof and one or more of water insoluble Zinc salt, complex or derivative thereof and one or more water insoluble Magnesium salt, complex or derivative thereof with at least one agrochemically acceptable excipient in an air mill or a jet mill to obtain a homogeneous mixture with fine particle size. Water is added to the dry powder and the mixture is blended to obtain a dough or paste, which is then extruded through an extruder, followed by sieving to remove the under sized and oversized granules to obtain the granules in the size range of 0.05-4.0 mm.

According to an embodiment, the invention further relates to the use of the crop nutrition composition as at least one of a nutrient composition, a crop strengthener composition, a soil conditioner composition, crop protection and a yield enhancer composition.

According to an embodiment, the invention further relates to a method for improving plant health or yield wherein the method comprises treating at least one of a plant, a plant propagation material, locus or parts thereof, a seed, seedling; or surrounding soil with the water dispersible granular composition of the present invention.

According to an embodiment, the invention also relates to a method of application of an effective amount of the crop nutrition composition in the form of water dispersible granules comprising a homogeneous mixture of 1% to 50% by weight of one or more water insoluble Iron salt, complex or derivative thereof, 1% to 80% by weight of one or more water insoluble Magnesium salt, complex or derivative thereof, 1% to 50% by weight of one or more water insoluble Zinc salt, complex or derivative thereof and 0.01%-97% by weight of agrochemically acceptable excipient, wherein the granules of the composition are in the size range of 0.0 mm 5-4.0 mm and comprises of particles in the size range of 0.1 micron-20 microns and wherein the composition is applied to the seeds, seedlings, crops, a plant, plant propagation material, locus, parts thereof or to the surrounding soil.

According to an embodiment, the present invention relates to a method of treating plants and meeting their nutritional requirement by making essential nutrients like Magnesium, Zinc and Iron available to them and also unlocking the other micronutrients and trace elements presents present in the soil and making them available to the plant which hitherto were not available because of various factors primarily being soil degradation on account of excessive use of synthetic fertilizers. The present invention also relates to strengthening the plants so as to withstand pest infestation. The present invention also relates to a method of biofortification of plant with essential micronutrients.

The present invention further provides balanced uptake of all nutrients, improves the crop health, improves the crop nutrition by facilitating the uptake of essential nutrients, protects the crop, enhances the crop yield, strengthens the plant or assists in conditioning the soil.

According to an embodiment, the present invention relates to a method for treating plants and meeting their nutritional requirement by enhancing uptake of Magnesium, Zinc and Iron by application of a composition comprising a homogeneous mixture of:
at least one water insoluble Iron salt, complex or derivative thereof in the range of 1-50% w/w of the total composition,
at least one water insoluble Zinc salt, complex or derivative thereof in the range of 1-50% w/w of the total composition,
at least one water insoluble Magnesium salt, complex or derivative thereof in the range of 1-80% w/w of the total composition,
at least one agrochemically acceptable excipient in the range of 0.01-97% w/w of the total composition,
wherein the granules of the composition are in the size range of 0.05 mm-4.0 mm and comprise particles in the size range of 0.1 micron-20 microns.

The composition of the present invention further assists in regulating the soil pH so as to facilitate the balance uptake of micronutrients. Further, the composition of present invention was found to be effective independent of the soil pH making it a viable composition for all types of soils. More importantly, it was noted that the presence of Magnesium along with Zinc and Iron in the form of the composition of the present invention facilitated not only an uptake of significant proportion of Iron and Zinc present in the composition but also enabled plant uptake of micro nutrients like Boron, Manganese, Calcium etc entrapped in the soil.

The composition of the present invention was found to play a vital role in regulating soil pH and facilitating the uptake of nutrients even in soils which have been degraded or whose pH have been altered because of excessive use of synthetic fertilizers. The composition of the present invention met the nutritional need of plants by providing a balanced uptake of essential nutrients like Zinc, Iron and Magnesium, thus overcoming the challenge of providing a nutrient rich crop in calcareous soils which is known to provide an antagonism challenge for the uptake of these nutrients. It was further surprising to observe that the balanced uptake of nutrients leads to a healthier plant that could withstand pest infestation, a higher nutrient harvest in all soils types and finally improving the overall soil health. The present composition acts as a nutrient use efficient composition while meeting the need of crops by providing a multi nutritive solution with improved uptake by crops in a single application.

The present composition can be applied through a variety of methods. Methods of applying to the soil includes any suitable method, which ensures that the composition penetrates the soil, for example, nursery tray application, in furrow application, drip irrigation, sprinkler irrigation, soil drenching, soil injection, or incorporation into the soil, and such other methods. The composition also can be applied in the form of a foliar spray.

The rates of application or the dosage of the composition depends on the type of use, the type of crops, or the specific active ingredients in the composition but is such that the active ingredient, is in an effective amount to provide the desired action such as crop protection, crop yield and nutrient uptake.

### A. Preparation Examples

The following examples illustrate the basic methodology and versatility of the composition of the invention. The water insoluble sources of Iron, Magnesium and Zinc exemplified in the preparatory examples can be replaced by any other water insoluble salts, complexes or derivatives thereof of these nutrients as covered in the present invention varying the claimed concentration ranges respectively. It should be noted that this invention is not limited to these exemplifications.

### Water Dispersible Granular Composition of Water Insoluble Magnesium Salt, Water Insoluble Zinc Salt and Water Insoluble Iron Salt:

1. Water dispersible granular composition of 1% Ferric Oxide, 40% Magnesium Oxide and 40% Zinc Oxide.
   Water dispersible granular composition was prepared by blending 1 part of Ferric Oxide, 40 parts of Magnesium Oxide and 40 parts of Zinc Oxide, 2 parts of Naphthalene Sulphonate Condensate, 7 parts of Sodium Lignosulfonate, 5 parts of Kaolin and 5 parts of Sodium Citrate to obtain a blend. The blend obtained was milled to get a powder of less than 15 microns size. The powder was mixed with water in a suitable mixing equipment to form a slurry or wet mix.
   The slurry obtained was wet ground in suitable wet grinding equipment. The wet milled slurry obtained was spray dried at an inlet temperature less than 175° C. and outlet temperature less than 90° C. to get granules. The composition has a particle size distribution D90 of 5.5 microns. The granule size of the composition is in the range of 0.1-1.5 mm. The composition has a dispersibility of 75%, suspensibility of 65%, and wettability of less than 25 sec. The composition further demonstrated a suspensibility of about 63% and dispersibility of 71%, wettability of 30 seconds under accelerated storage condition.
2. Water dispersible granular composition of 50% Zinc Hydroxide, 40% Magnesium carbonate and 1% Iron fumarate.
   The water dispersible composition is prepared as per Example 1 by blending 40 parts of Magnesium Carbonate, 50 parts of Zinc Hydroxide, 1 part of Iron Fumarate, 4 parts of naphthalene sulphonate sodium condensate salt, 3 part of polycarboxylate sodium and 2 parts of soapstone (talc) The composition has a particle size distribution D90 less than 6.3 microns. The granule size of the composition is in the range of 0.1-2 mm. The composition has a dispersibility of 85%, suspensibility of 80%, and wettability of less than 20 sec. The composition further demonstrated a suspensibility of about 75% and dispersibility of 81%, wettability of 25 seconds under accelerated storage condition.
3. Water dispersible granular composition of 40% Zinc Borate, 23% Magnesium Silicate and 1% Iron Phosphate.
   The water dispersible composition is prepared as per Example 1 by blending 23 parts of Magnesium Silicate, 40 parts of Zinc Borate, 1 part of Iron Phosphate, 2 parts of Soprophor 4D/384 (Fulvic acid), 6 part of Lignin Sulphonate Sodium, 2 parts of Polycarboxylate Sodium, 10 parts of Fulvic Acid, 6 parts of Sodium Citrate and 10 parts of China Clay. The composition has particle size distribution D90 of 7.9 microns. The granule size of the composition is in the range of 0.1-1.5 mm. The composition has a dispersibility of 75%, suspensibility of 68%, and wettability of less than 30 sec. The composition further demonstrated suspensibility of about 62% and dispersibility of 72%, wettability of 38 seconds under accelerated storage condition.
4. Water dispersible granular composition of 4% Zinc Sulphide, 8% Magnesium Oxide and 1% Ferric Oxide.
   The water dispersible composition is prepared as per Example 1 by blending 8 parts of Magnesium Oxide, 4 part of Zinc Sulphide, 1 part of Ferric Oxide, 8 parts Gum Arabic, 17 parts of Fulvic acid, and 30 parts of Stepsperse DF200 and 32 parts of Lignosulphonate. The composition has particle size distribution D90 of 6.5 microns. The granule size of the composition is in the range of 0.1-2.5 mm. The composition has a dispersibility of 65%, suspensibility of 58%, and wettability of less than 23 sec. The composition further demonstrated suspensibility of about 55% and dispersibility of 60%, wettability of 32 seconds under accelerated storage condition.
5. Water dispersible granular composition of 4% Zinc Silicate, 71% Magnesium Carbonate and 5% Ferrous Fumarate.
   The water dispersible composition is prepared as per Example 1 by blending 71 parts of Magnesium Carbonate, 4 parts of Zinc Silicate, 5 part of Ferrous Fumarate, 7 parts Neem gum, 3 parts of Naphthalene Sulphonate Condensate Sodium Salt, 5 parts of Kaolin and 5 parts of Lactose. The composition has particle size distribution D90 of 4.5 microns. The granule size of the composition is in the range of 0.1-2.5 mm. The composition has a dispersibility of 71%, suspensibility of 65%, and wettability of less than 15 sec. The composition further demonstrated suspensibility of about 62% and dispersibility of 65%, wettability of 25 seconds under accelerated storage condition.
6. Water dispersible granular composition of 9% Zinc Phosphate, 60% Magnesium Silicate and 11% Iron Oxalate.
   The water dispersible composition is prepared as per Example 1 by blending 60 parts of Magnesium Silicate, 9 parts of Zinc Phosphate, 11 part of Iron Oxalate, 4 parts of Polyacrylate Sodium, 3 parts of Naphthalene Sulphonate Condensate Sodium Salt, 6 parts of Gum Ghatti and 7 parts of Fulvic acid. The composition has particle size distribution D90 of 5 microns. The granule size of the composition is in the range of 0.1-1.5 mm. The composition has a dispersibility of 55%, suspensibility of 45%, and wettability of less than 30 sec. The composition further demonstrated suspensibility of about 40% and dispersibility of 51%, wettability of 35 seconds under accelerated storage condition.
7. Water dispersible granular composition of 20% Zinc Oxide, 30% Magnesium Carbonate and 40% Iron Silicate
   The water dispersible composition is prepared as per Example 1 by blending 30 parts of Magnesium Carbonate, 20 parts of Zinc Oxide, 40 part of Iron Silicate, 4 parts of Naphthalene Sulphonate Condensate Sodium Salt, 2 parts of Larch Gum, 3 parts of Stepsperse DF200 and 1 part of Sodium Citrate. The composition has particle size distribution D90 of 9.5 microns. The granule size of the composition is in the range of 0.1-2.5 mm. The composition has a dispersibility of 45%, suspensibility of 40%, and wettability of less than 30 sec. The composition further demonstrated suspensibility of about 38%, dispersibility of 40%, wettability of 35 seconds under accelerated storage condition.
8. Water dispersible granular composition of 35% Zinc Phosphate, 25% Magnesium Phosphate and 17% Iron Phosphate.
   The water dispersible composition is prepared as per Example 1 by blending 35 parts of Zinc Phosphate, 25 parts of Magnesium Phosphate, 17 part of Iron Phosphate, 3 parts of Phosphate Ester Surfactant, 3 parts of Naphthalene Sulphonate Condensate Sodium Salt, 10 parts of Fulvic acid, and 7 part of Kaolin. The composition has a particle size distribution D90 of 9.5 microns. The granule size of the composition is in the range of 0.1-2.0 mm. The composition has a dispersibility of 82%, suspensibility of 70%, and wettability of less than 28 sec. The composition further demonstrated a suspensibility of about 64% and dispersibility of 77%, wettability of 35 seconds under accelerated storage condition.
9. Water dispersible granular composition of 12% Zinc Hydroxide, 25% Magnesium Hydroxide and 50% Iron Hydroxide
   The water dispersible composition is prepared as per Example 1 by blending 12 parts of Zinc Hydroxide, 25 parts of Magnesium Hydroxide and 50 parts of Iron Hydroxide, 7 parts of Geropon T77, 3 parts of Gum Arabic and 3 parts of Fulvic acid. The composition has a particle size distribution D90 of 12 microns. The granule size of the composition is in the range of 0.1-2.0 mm. The composition has a dispersibility of 89%, suspensibility of 80%, and wettability of less than 12 sec. The composition further demonstrated a suspensibility of about 76% and dispersibility of 85%, wettability of 20 seconds under accelerated storage condition.
10. Water dispersible granular composition of 30% Zinc Oxide, 25% Ferric Oxide and 35% Magnesium Oxide.
   The water dispersible composition is prepared by blending 30 parts of Zinc Oxide, 25 part of Ferric Oxide, 35 parts of Magnesium Oxide, 5 parts of Sodium Alkyl Benzene Sulfonate, 3 parts of Sodium Salt of Polycarboxylic Acid and 2 parts of Silica. The blend obtained was milled to get a powder of less than 15 microns size. The powder was mixed with water in a suitable mixing equipment to form a slurry or wet mix. Extruding the wet mass through a suitable extruder and drying the extruded granules in a suitable dryer to obtain extruded granules. The composition has following particle size distribution: D90 of 15 microns. The granule size of the composition is in the range of 0.1 mm-4 mm. The composition has a dispersibility of 75%, suspensibility of 70%, and wettability of less than 20 sec. The composition further demonstrated a suspensibility of about 65%, dispersibility of about 70% and wettability of about 15 seconds under accelerated storage condition.

### B. Field Study

Experiment 1: To study the impact of Water dispersible granules comprising water insoluble Zinc salt and water insoluble Magnesium salt and water insoluble Iron salt in Wheat.

### Field Experiment Methodology

The field trial was carried out to see the effect of Water dispersible granular composition comprising water insoluble Zinc salt and water insoluble Magnesium salt and water insoluble Iron salt in Wheat at Karnal, Haryana. The trial was laid out during Rabi season in Randomized Block Design (RBD) with thirteen treatments including untreated control, replicated four times. For each treatment, plot size of 30 sq. m (6m×5m) was maintained. The test product compounds various Zinc salts, Iron salts, Magnesium salts alone and their combination in water dispersible granular composition as per the present invention varying concentration range with prescribed dose were applied to the soil at the time of 1^{st} irrigation of wheat (25 days after sowing). The Wheat crop in trial field was raised following good agricultural practices.

### Details of Experiment

a) Trial Location: Karnal, Haryana
b) Crop: Wheat (var: PBW 343)
c) Experiment season: Rabi 2021
d) Trial Design: Randomized Block Design
e) Replications: Four
f) Treatment: Six
g) Plot size: 6m×5m=30 sq. m
h) Date of sowing: 4 Nov. 2021
i) Date of Application: 30 Nov. 2021
j) Method of application: Soil application
k) Date of Harvesting: 19 Apr. 2022
l) Soil pH: 6.5-7

The observations were recorded at the harvesting time and the mean data was presented in Table 1 to enumerate the efficacy of the water dispersible granular composition prepared as per the embodiment of the present invention.

TABLE 1

| | Dose of nutrient salt in | | | | | Expected |
|---|---|---|---|---|---|---|
| | g/ha | | | | % increase | % |
| | Zinc | Iron | Magnesium | Yield | in yield over | increases |
| Treatment Details | (Zn) | (Fe) | (Mg) | (Qt/ha) | untreated | in yield |
| T1-32% Zinc Oxide | 120.51 | | | 32 | 3.23 | — |
| WDG | | | | | | |
| T2-15% Iron (II) | | 116.61 | | 32 | 3.23 | — |
| oxide WDG | | | | | | |
| T3-40% Magnesium | | | 833.68 | 34 | 9.67 | — |
| Hydroxide WDG | | | | | | |
| T4-Zinc Oxide 6% + | 120.51 | 116.61 | 833.68 | 40 | 29.03 | 21.44 |
| Iron (II) Oxide 6% + | | | | | | (1.35)* |
| Magnesium | | | | | | |
| Hydroxide 80%- | | | | | | |
| WDG prepared as | | | | | | |
| per the embodiment | | | | | | |
| of the present | | | | | | |
| invention | | | | | | |
| T5-20% Zinc Borate | 500.04 | | | 34 | 9.68 | — |
| WDG | | | | | | |
| T6-22% Iron | | 216.96 | | 32 | 3.23 | — |
| Fumarate WDG | | | | | | |
| T7-36% Magnesium | | | 217.11 | 35 | 12.90 | — |
| Oxide WDG | | | | | | |
| T8-Zinc Borate 40% + | 500.04 | 216.96 | 217.11 | 41 | 32.26 | 23.83 |
| Iron Fumarate 33% + | | | | | | (1.35)* |
| Magnesium Oxide | | | | | | |
| 18%-WDG prepared | | | | | | |
| as per the | | | | | | |
| embodiment of the | | | | | | |
| present invention | | | | | | |
| T9-30% Zinc Oxide | 482.03 | | | 34 | 9.68 | — |
| WDG | | | | | | |
| T10-30% Iron | | 394.23 | | 33 | 6.45 | — |
| Silicate WDG | | | | | | |
| T11-30% | | | 259.51 | 36 | 16.13 | — |
| Magnesium | | | | | | |
| Carbonate WDG | | | | | | |
| T12-Zinc Oxide | 482.03 | 394.23 | 259.51 | 43.5 | 40.32 | 29.03 |
| 20% + Iron Silicate | | | | | | (1.39)* |
| 40% + Magnesium | | | | | | |
| Carbonate 30%- | | | | | | |
| WDG prepared as | | | | | | |
| per the embodiment | | | | | | |
| of the present | | | | | | |
| invention | | | | | | |
| T13-Zinc Oxide | 482.03 | 394.23 | 0.0 | 29 | | — |
| 20% + Iron Silicate | | | | | | |
| 40%-WDG | | | | | | |
| T14-Untreated | | | | 31 | | — |
| CD at 0.05% | — | — | | | | — |
| | | Number | | | | |
| | Plant | of | Root | Uptake of Nutrients | | |
| | Height | Tillers/ | Development | (mg/100 g of seeds) | | |
| Treatment Details | (cm) | plant | (cm) | Zn | Fe | Mg |
| T1-32% Zinc Oxide WDG | 35 | 4 | 3.80 | 1.8 | 1.1 | 76 |
| T2-15% Iron (II) oxide | 32 | 5 | 3.90 | 1.7 | 1.3 | 76 |
| WDG | | | | | | |
| T3-40% Magnesium | 40 | 6.5 | 4.00 | 1.6 | 1.2 | 105 |
| Hydroxide WDG | | | | | | |
| T4-Zinc Oxide 6% + Iron | 45.10 | 7.10 | 6.00 | 4.2 | 3.6 | 125 |
| (II) Oxide 6% + | | | | | | |
| Magnesium Hydroxide | | | | | | |
| 80%-WDG prepared as per | | | | | | |
| the embodiment of the | | | | | | |
| present invention | | | | | | |
| T5-20% Zinc Borate WDG | 43.20 | 6.30 | 5.00 | 2.1 | 1.2 | 67 |
| T6-22% Iron fumarate | 35.00 | 6.10 | 4.80 | 1.4 | 1.3 | 65 |
| WDG | | | | | | |
| T7-36% Magnesium | 32.00 | 5.70 | 4.80 | 1.5 | 1.2 | 70 |
| Oxide WDG | | | | | | |
| T8-Zinc Borate 40% + | 47.90 | 7.50 | 7.00 | 4.5 | 3.5 | 110 |
| Iron Fumarate 33% + | | | | | | |
| Magnesium Oxide 18%- | | | | | | |
| WDG prepared as per the | | | | | | |
| embodiment of the present | | | | | | |
| invention | | | | | | |
| T9-30% Zinc Oxide WDG | 41.70 | 5.40 | 5.00 | 1.1 | 1.2 | 77 |
| T10-30% Iron Silicate | 39.50 | 6.20 | 5.00 | 1.6 | 1.5 | 75 |
| WDG | | | | | | |
| T11-30% Magnesium | 33.00 | 6.00 | 4.00 | 1.7 | 1.2 | 80 |
| Carbonate WDG | | | | | | |
| T12-Zinc Oxide 20% + | 48.00 | 8.00 | 7.00 | 3.8 | 3.7 | 124 |
| Iron Silicate 40% + | | | | | | |
| Magnesium Carbonate | | | | | | |
| 30%-WDG prepared as per | | | | | | |
| the embodiment of the | | | | | | |
| present invention | | | | | | |
| T13-Zinc Oxide 20% + | 30.00 | 3.80 | 3.00 | 1.6 | 1.1 | 75 |
| Iron Silicate 40% -WDG | | | | | | |
| T14-Untreated | 29.00 | 3.20 | 3 | 1.3 | 1.0 | 70 |
| CD at 0.05% | | | | | | |

*Synergy factor
*The Magnesium, Iron and Zinc salts selected and the concentration range of these nutrients covered in above table are exemplary and can be replaced with other water insoluble Magnesium, Iron and Zinc salts as per the embodiment of the present invention.

From the data observed in the Table 1, it can be seen that the compositions T4, T8 and T12 as per the embodiments of the present invention demonstrate a synergistic behavior.

“Synergy” is as defined by Colby S. R. in an article entitled “Calculation of the synergistic and antagonistic responses of herbicide combinations” published in Weeds, 1967, 15, p. 20-22. The action expected for a given combination of two active components can be calculated as follows:

$$E = X + Y + Z - ( XY + YZ + XZ ) / 100 + ( XYZ ) / 10000$$

Where,
E=Expected % effect by mixture of two products X, Y and Z in a defined dose.
X=Observed % effect by product A
Y=Observed % effect by product B
Z=Observed % effect by product C

The synergy factor (SF) is calculated by Abbott's formula (Eq. (2) (Abbott, 1925).

$$SF = Observed effect / Expected effect$$

Where, SF>1 for Synergistic reaction; SF<1 for antagonistic reaction; SF=1 for additive reaction.

When the percentage of yield effect observed for the combination is greater than the expected percentage, synergistic effect of the combination can be inferred. When the percentage of yield effect observed for the combination is equal to the expected percentage, merely an additive effect may be inferred, and wherein the percentage of yield effect observed for the combination is lower than the expected percentage, an antagonistic effect of the combinations can be inferred.

It can be observed that the synergy factor is 1.35, 1.35 and 1.39 for treatments T4, T8 and T12 as seen from Table 1 which depicts that the WDG compositions of “Zinc Oxide+Iron (II) oxide+Magnesium Hydroxide”, “Zinc Borate+Iron Fumarate+Magnesium Oxide” and “Zinc Oxide+Iron Silicate+Magnesium Carbonate” respectively are synergistic in nature. This synergistic behavior of “water insoluble Zinc salt and water insoluble Magnesium salt and water insoluble Iron salt” in the form of WDG as per embodiment of the present invention can be observed from the yield of Wheat crop. The four treatments namely T1 (32% Zinc Oxide WDG), T2 (15% Iron (II) oxide WDG), T3 (40% Magnesium Hydroxide WDG) and T4 (Zinc Oxide 6%+Iron (II) oxide 6%+Magnesium Hydroxide 80%−WDG) were applied at same active dosage i. e. 120.51 gm/ha of Zinc, 116.61 gm/ha of Iron and 833.68 gm/ha of Magnesium. Treatment T4 exhibits highest yield of about 40 quintal (Qt)/ha when compared to treatment T1 with a yield-d−32 Qt/ha, T2 with a yield−32 Qt/ha and T3 with a yield−34 Qt/ha. The expected % increase in yield was 21.44% but the observed % increase in yield for Treatment T4 was 29.03%, demonstrating synergistic effect.

Thus, the combination of Zinc Oxide 6%+Iron (II) Oxide 6%+Magnesium Hydroxide 80% in WDG form as per embodiment of the present invention is synergistic and provides higher crop yield as compared to the application of individual actives when applied at the same dosage. Similar trends in terms of yield were also observed with the treatments T8, T12 when compared to treatments T5, T6, T7 and treatments T9, T10, T11 respectively which depicts the synergistic behavior of the compositions as per the embodiment of the present invention.

It can be appreciated from the observed results that plant height and number of tillers in Wheat crop were higher in treatment T12 with 20% Zinc Oxide+40% Iron Silicate+30% Magnesium Carbonate-WDG as compared to the individual applications of actives i.e. T9 with 30% Zinc Oxide WDG, T10 with 30% Iron Silicate WDG and T11 with 30% Magnesium Carbonate WDG. On comparing treatments T9-T12, it can be noted that Treatment T12 has plant height and number of tillers of 48 cm and 8 respectively whereas treatment T9, T10 and T11 has a plant height of 41.70, 39.50, 33 cm, and 5, 5, and 4 tillers respectively.

The untreated control also has a plant height of 29 cm, and 3 tillers. It was also observed that the leaves of wheat plot treated with treatments T4, T8 and T12 were greener as compared to Treatments T1-T3, T5-T7, T9-T11 and the untreated plot where yellow leaves were observed.

From Table 1 it can also be observed that availability of Zinc, Magnesium and Iron with respect to WDG composition prepared according to an embodiment of the present invention is greater than those observed with the same actives applied stand alone at soil pH 6.5-7. It can be also seen that 4.5 mg, 3.5 mg and 110 mg of Zinc, Iron and Magnesium were available for uptake with respect to the WDG composition of T8-Zinc Borate 40%+Iron Fumarate 33%+Magnesium Oxide 18% whereas only 2.1 mg, 1.4 mg, 1.5 mg of Zinc, 1.2 mg, 1.3 mg, 1.2 mg of Iron and 67 mg, 65 mg, 70 mg of Magnesium were available for uptake to the plants by application of treatments T5, T6 and T7 of the individual actives respectively.

Further, the observed uptake of Zinc, Iron and Magnesium by the application of Treatment T12 wherein the WDG composition was prepared according to an embodiment of the present invention was found to be higher when compared to individual treatments T9-T12 as well as treatment T13 i.e. a WDG composition of Zinc Oxide 20%+Iron Silicate 40% where the active Zn and Fe were applied at same active dosage as that of T9-T12. It was surprising to observe that only 1.6 mg of Zinc, 1.1 mg of Iron and 75 mg of Magnesium were available for uptake with respect to treatment T13. However, with the application of T12-Zinc Oxide 20%+Iron silicate 40%+Magnesium Carbonate 30%−WDG, the availability of Zinc, Iron and Magnesium was drastically increased to 3.8 mg, 3.7 mg and 124 mg respectively despite T12 and T13 being applied at same active dosage of Zinc and Iron. This appreciable increase in the availability of Zinc and Iron observed in Treatment T12 was noted to be on account of the presence of Magnesium along with Zinc and Iron in the composition formulated as per the embodiment of the invention i.e., in the form of a water dispersible granules with particle size in the range of 0.1 microns to 20 microns in Treatment T12 which facilitated the increased availability of the entire range of micronutrients present in the composition i.e., Magnesium, Iron and Zinc for uptake by the crops.

It was thus noted that the composition comprising a combination of water insoluble Zinc salt and water insoluble Magnesium salt and water insoluble Iron salt in the form of water dispersible granules demonstrates a better uptake of Magnesium, Zinc and Iron when compared to an individual application of the said actives as well as an application of a composition of only Iron and Zinc which is devoid of Magnesium.

From the aforementioned data, it can be concluded that the composition comprising of “water insoluble Zinc salt and water insoluble Magnesium salt and water insoluble Iron salt” in the form of WDG as per the embodiment of the present invention at different dosages and at claimed concentration ranges demonstrated significantly higher uptake of micronutrients, higher yield, plant height, root development and number of tillers.

The inventors of the present invention have further observed that apart from the Zinc, Magnesium and Iron salts listed in the Table 1 above, other Zinc, Magnesium and Iron Salts as claimed in the present application also exhibited similar effect when applied as per the embodiment of the present invention.

### Experiment 2: To Study the Effect of Water Dispersible Granular Composition of Present Invention on Groundnut Crop

Field trial was conducted for the evaluation of an embodiment of the composition of the present invention at Wadgaon Khed, Maharashtra on Groundnut crop, variety: Kasturi 108. The trials were laid down in Randomized Block Design (RBD) with nine treatments including untreated control, replicated four times. For each treatment, plot size of 35 sq. m (7m×5m) was maintained. The test nutritional compositions various Zinc salts, Iron salts, Magnesium salts alone and their combination in water dispersible granules as per the present invention varying concentration range with prescribed dose were applied as basal application at the time of sowing of Groundnut crop.

The details of the experiment are as follows:
a) Trial Location: Wadgaon Khed, Maharashtra
b) Crop: Groundnut (var: Kasturi 108)
c) Experiment season: Rabi 2022
d) Trial Design: Randomized Block Design
e) Replications: Four
f) Treatment: Six
g) Plot size: 7m×5m=35 sq. m
h) Date of Application: 17 Jan. 2022
i) Date of sowing: 18 Jan. 2022
j) Method of application: Basal
k) Date of Harvesting: 17 Jun. 2022
l) Soil pH: 6.5-7

The observations were recorded at the harvesting time and the mean data was presented in Table 2 to enumerate the efficacy of the water dispersible granules of “water insoluble Zinc salt and water insoluble Magnesium salt and water insoluble Iron salt” prepared as per the embodiment of the present invention.

TABLE 2

| | | | | | | | Ground | % | |
|---|---|---|---|---|---|---|---|---|---|
| | Dose of nutrient salt in | | | | | | nut | increase | Expected |
| | g/ha | | | Uptake of Nutrients | | | kernel | in yield | % |
| Treatment | Zinc | Iron | Magnesium | (mg/100 g of seeds) | | | Yield | over | increases |
| Details | (Zn) | (Fe) | (Mg) | Zn | Fe | Mg | (Kg/ha) | untreated | in yield |
| T1-20% Zinc | 625.05 | | | 2.7 | 0.12 | 85 | 1126 | 10.39 | — |
| Borate WDG | | | | | | | | | |
| T2-24% Iron | | 394.30 | | 0.1 | 0.41 | 80 | 1100 | 7.84 | — |
| Silicate WDG | | | | | | | | | |
| T3-20% | | | 120.62 | 0.2 | 0.13 | 90 | 1160 | 13.73 | — |
| Magnesium | | | | | | | | | |
| Oxide WDG | | | | | | | | | |
| T4-Zinc Borate | 625.05 | 394.30 | 120.62 | 4.8 | 3.22 | 200 | 1450 | 42.16 | 32.07 |
| 5% + Iron | | | | | | | | | (1.31)* |
| Silicate 6% + | | | | | | | | | |
| Magnesium | | | | | | | | | |
| Oxide 1%- | | | | | | | | | |
| WDG prepared | | | | | | | | | |
| as per the | | | | | | | | | |
| embodiment of | | | | | | | | | |
| the present | | | | | | | | | |
| invention | | | | | | | | | |
| T5-30% Zinc | 352.14 | | | 1.9 | 0.12 | 65 | 1090 | 6.86 | — |
| Silicate WDG | | | | | | | | | |
| T6-30% Iron | | 295.85 | | 0.2 | 1.1 | 60 | 1067 | 4.61 | — |
| Fumarate WDG | | | | | | | | | |
| T7-40% | | | 346.01 | 0.1 | 0.13 | 70 | 1200 | 17.65 | — |
| Magnesium | | | | | | | | | |
| Carbonate | | | | | | | | | |
| WDG | | | | | | | | | |
| T8-Zinc | 352.14 | 295.85 | 346.01 | 5.67 | 3.9 | 160 | 1555 | 52.45 | 32.06 |
| Silicate 20% + | | | | | | | | | (1.63)* |
| Iron Fumarate | | | | | | | | | |
| 30% + | | | | | | | | | |
| Magnesium | | | | | | | | | |
| Carbonate | | | | | | | | | |
| 40%-WDG | | | | | | | | | |
| prepared as per | | | | | | | | | |
| the | | | | | | | | | |
| embodiment of | | | | | | | | | |
| the present | | | | | | | | | |
| invention | | | | | | | | | |
| T9-Untreated | | | | 0.1 | 0.12 | 105 | 1020 | 10.39 | — |
| CD at 0.05% | — | — | | | | | | | — |

| | | | | Pest | % |
|---|---|---|---|---|---|
| | No of | Plant | No of | (Fusarium | increase |
| | Pods/ | Height | Branches/ | Wilt) % | in wilt |
| Treatment Details | Plant | (cm) | Plant | Control | control |
| T1-20% Zinc | 14.9 | 37.00 | 2.5 | 20 | 11.11 |
| Borate WDG | | | | | |
| T2-24% Iron | 14.7 | 32.00 | 1.9 | 19 | 5.55 |
| Silicate WDG | | | | | |
| T3-20% | 14.1 | 35.00 | 3.1 | 20 | 11.11 |
| Magnesium | | | | | |
| Oxide WDG | | | | | |
| T4-Zinc Borate | 16.5 | 44.70 | 6.8 | 33 | 83.3 |
| 5% + Iron Silicate | | | | | |
| 6% + Magnesium | | | | | |
| Oxide 1%-WDG | | | | | |
| prepared as per | | | | | |
| the embodiment | | | | | |
| of the present | | | | | |
| invention | | | | | |
| T5-30% Zinc | 14.5 | 36.50 | 3.6 | 19 | 5.55 |
| Silicate WDG | | | | | |
| T6-30% Iron | 14.6 | 31.50 | 2.5 | 20 | 11.11 |
| Fumarate WDG | | | | | |
| T7-40% | 14.9 | 37.30 | 4 | 21 | 16.6 |
| Magnesium | | | | | |
| Carbonate WDG | | | | | |
| T8-Zinc Silicate | 16.8 | 42.30 | 7.5 | 31 | 72.2 |
| 20% + Iron | | | | | |
| Fumarate 30% + | | | | | |
| Magnesium | | | | | |
| Carbonate 40%- | | | | | |
| WDG prepared as | | | | | |
| per the | | | | | |
| embodiment of | | | | | |
| the present | | | | | |
| invention | | | | | |
| T9-Untreated | 14 | 31.00 | 2.1 | 18 | — |
| CD at 0.05% | — | — | — | — | — |

From the data observed in the Table 2, it can be seen that the compositions T4, T8 as per the embodiments of the present invention demonstrate a synergistic behavior.

The water insoluble Iron salt, water insoluble Zinc salt and water insoluble Magnesium salt selected and the concentration used in above table are exemplary and can be replaced with another water insoluble Iron salt, water insoluble Zinc salt and water insoluble Magnesium salt respectively as per the embodiment of the present invention.

Based on the data presented in Table 2 and the calculations made, the expected percentage increase in the groundnut kernel yield was found to be 32.07% and 32.06%. However, it can be clearly seen from the Table 2 above that the treatment T4 with Zinc Borate 5%+Iron Silicate 6%+Magnesium Oxide 1%−WDG as per the embodiment of the present invention showed a yield increase of 42.16% of Groundnut kernel and treatment T8 with Zinc Silicate 20%+Iron Fumarate 30%+Magnesium Carbonate 40%−WDG composition, as per the embodiment of the present invention showed a yield increase of 52.45% of Groundnut kernel.

However, treatments T1 with 20% Zinc Borate WDG, T2 with 24% Iron Silicate WDG and T3 with 20% Magnesium Oxide WDG demonstrated only a 10.39%, 7.84% and 13.73% increase in the kernel yield of Groundnut crop respectively.

Similarly, treatments T5 with 30% Zinc Silicate WDG, T6 with 30% Iron Fumarate WDG and T7 with 40% Magnesium Carbonate WDG demonstrated only a 6.86%, 4.61% and 17.65% increase in the kernel yield of Groundnut crop respectively. Thus, the treatments T4 and T8 with water dispersible granules as per the embodiments of the present invention demonstrated a synergistic effect, as compared to the treatment with individual actives. The results are all the more surprising as all the treatments T1-T4 and T5-T8 were applied at same dosage of Zinc salt, Iron salt and Magnesium salt being applied to the soil i.e. 625.05 g/ha of Zinc, 394.30 g/ha of Iron, 120.62 g/ha of Magnesium and 352.14 g/ha of Zinc, 295.85 g/ha of Iron, 346.01 g/ha of Magnesium respectively.

Further, Treatments T4 and T8 exhibited highest number of pods/plant of about 16.5 and 16.8 respectively when compared to number of pods/plant observed for treatments T1-T7 i.e. between 14.1-14.9.

It was also observed that Treatments T4, T8 with compositions as per the embodiments of the present invention were highly effective in controlling the Fusarium wilt fungus in brinjal at harvest as compared to the Treatments T1-T3 and T5-T7. The % control was observed to be 83.3% and 72.2% by the application of T4, T8 respectively as compared to be treatments T1-T3, T5-T7 which was 11.11%, 5.55%, 11.11%, 5.55%, 11.11% and 16.6% respectively. It can be observed that the composition of the present invention could meet the overall nutritional requirement of plants and as a consequence it can withstand pest infestation eventually resulting in better yield.

It can be further seen from Table 2 that the treatments T4 and T8 with compositions as per the embodiment of the present invention showed a surprising uptake of nutrients like Zinc, Magnesium and Iron which was not observed with treatments T1-T3 and T5-T7 i.e. an individual application of the said actives even when the actives are applied at same dosages of application at a soil pH of 6.5-7. This appreciable increase in the availability of nutrients observed in Treatments T4, T8 was noted to be on account of the presence of Magnesium along with Zinc and Iron in the composition formulated as per the embodiment of the invention i.e., in the form of a water dispersible granules with particle size in the range of 0.1 microns to 20 microns which facilitated the increased availability of the entire range of micronutrients present in the composition i.e., Magnesium, Iron and Zinc for uptake by the crops.

From the aforementioned data, it can be concluded that the composition comprising of “water insoluble Zinc salt and water insoluble Magnesium salt and water insoluble Iron salt” in the form of WDG as per the embodiment of the present invention at different dosages and at claimed concentration ranges demonstrated significantly higher uptake of micronutrients, higher yield, number of pods/plants, plant height and number of branches/plants.

The inventors of the present invention have further observed that apart from the Zinc, Magnesium and Iron salts listed in the Table 2 above, other Zinc, Magnesium and Iron Salts as claimed in the present application also exhibited similar effect when applied as per the embodiment of the present invention.

### Experiment No 3: To Assess the Impact of Particle Size Distribution in the Composition Comprising Zinc Oxide+Ferric Oxide+Magnesium Oxide-WDG on Yield of Cauliflower

### Field Experiment Methodology

The field trials were carried out to observe the effect of different ranges of particle size with regard to the composition of Zinc Oxide+Ferric oxide+Magnesium Oxide-WDG on the yield of Cauliflower at Nasik, Maharashtra.

The trial was laid out during spring season in Randomized Block Design (RBD) with five treatments including untreated control, replicated four times. For each treatment, plot size of 30 sq. m (6m×5m) was maintained. The test products with prescribed dose were applied by drip irrigation at 15 days after transplanting of Cauliflower. The Cauliflower crop in trial field was raised following good agricultural practice. The seed of Cauliflower, variety Pant Shubhra, were used for sowing in 50 cm row to row and 30 cm plant to plant spacing.

### Details of Experiment

a) Trial Location: Nasik, Maharashtra
b) Crop: Cauliflower (Pant Shubhra)
c) Experiment season: Spring—March to May
d) Trial Design: Randomized Block Design
e) Replications: Four
f) Treatment: 5
g) Plot size: 6m×5m=30 sq. m
h) Date of transplanting: 1 Mar. 2022
i) Date of Application: 14 Mar. 2022
j) Method of application: Drip irrigation
k) Date of Harvesting: 13 May 2022

The observations on yield were recorded at the time of harvesting and the mean data was presented in table 3 to see the impact of particle size distribution of the WDG composition comprising “Water insoluble Zinc salt and Water insoluble Magnesium salt and water insoluble Iron salt” on yield of Cauliflower.

TABLE 3

| | | | | | | Uptake of | | |
|---|---|---|---|---|---|---|---|---|
| | Range of | | Dose of nutrient | | | Nutrients | | |
| | particle | Formulation | (g/ha) | | | (mg/100 g | | |
| | size of the | dose | Zinc | Iron | | of curd of | | |
| | composition | (g/ha) | (Zn) | (Fe) | Magnesium | Cauliflower) | | |
| Treatment Details | — | — | — | — | (Mg) | Zn | Fe | Mg |
| T1-Zinc Oxide 30% + | 0.1 to 20 | 1500 | 361.53 | 262.26 | 316.61 | 0.90 | 0.85 | 15.00 |
| Ferric oxide 25% + | microns | | | | | | | |
| Magnesium Oxide | | | | | | | | |
| 35%-WDG prepared | | | | | | | | |
| as per the embodiment | | | | | | | | |
| of the present | | | | | | | | |
| invention | | | | | | | | |
| T2-Zinc Oxide 30% + | 0.1 to 50 | 1500 | 361.53 | 262.26 | 316.61 | 0.17 | 0.2 | 8.40 |
| Ferric oxide 25% + | microns | | | | | | | |
| Magnesium Oxide | | | | | | | | |
| 35%-WDG | | | | | | | | |
| T3-Zinc Oxide 30% + | 0.1 to 100 | 1500 | 361.53 | 262.26 | 316.61 | 0.16 | 0.14 | 8.00 |
| Ferric oxide 25% + | microns | | | | | | | |
| Magnesium Oxide | | | | | | | | |
| 35%-WDG | | | | | | | | |
| T4-Untreated | — | — | — | — | — | 0.04 | 0.12 | 6.00 |
| CD (P> 0.05) | — | — | — | — | | | | |

| | Range of | | % Yield | Average |
|---|---|---|---|---|
| | particle size | | increase | Curd |
| | of the | Yield | over | Weight |
| Treatment Details | composition | (Kg/ha) | untreated | (g) |
| T1-Zinc Oxide 30% + | 0.1 to 20 | 2798 | 27.18 | 1000.00 |
| Ferric oxide 25% + | microns | | | |
| Magnesium Oxide 35%- | | | | |
| WDG prepared as per the | | | | |
| embodiment of the | | | | |
| present invention | | | | |
| T2-Zinc Oxide 30% + | 0.1 to 50 | 2450 | 11.36 | 885.50 |
| Ferric oxide 25% + | microns | | | |
| Magnesium Oxide 35%- | | | | |
| WDG | | | | |
| T3-Zinc Oxide 30% + | 0.1 to 100 | 2370 | 7.73 | 865.20 |
| Ferric oxide 25% + | microns | | | |
| Magnesium Oxide 35%- | | | | |
| WDG | | | | |
| T4-Untreated | — | 2200 | — | 800.2 |
| CD (P > 0.05) | — | | | |

It can be seen from the data presented in Table 3 that Treatment T1 (water dispersible granular composition of Zinc Oxide 30%+Ferric oxide 25%+Magnesium Oxide 35% with particle size in the range of 0.1 micron to 20 microns as per the embodiment of the present invention showed a significant increase in the yield and the average curd weight in Cauliflower, when compared to treatment T2 with Zinc Oxide 30%+Ferric Oxide 25%+Magnesium Oxide 35% water dispersible granules having particle size in the range of 0.1 to 50 microns, T3 with Zinc Oxide 30%+Ferric oxide 25%+Magnesium Oxide 35%−WDG having particle size in the range of 0.1 to 100 microns. It was observed that the Treatment T1 showed a surprisingly significant 27.18% increase in the Cauliflower yield whereas the treatments T2 and T3 only showed a yield increase of 11.36% and 7.73%, respectively as compared to the untreated control.

Further, the uptake of nutrients such as Iron, Magnesium, Zinc was found to be very high with the Treatment T1 as compared to Treatments T2 and T3. It was thus noted that the superior efficacy in terms of yield and uptake of nutrients was observed with the water dispersible granular formulation as per the present invention, where the composition comprised particles in the size range of 0.1 micron-20 microns when compared to water dispersible granular formulations with higher particle size ranges.

### Experiment 4: To Assess the Efficacy of Different Formulations of “Water Insoluble Iron Salt, Water-Insoluble Zinc Salt and Water-Insoluble Magnesium Salt” in Commercial Cultivated Tomato Crop Field

### Field Experiment Methodology

The trial was laid out during Kharif season in Randomized Block Design (RBD) with thirteen treatments including untreated control, replicated four times. For each treatment, plot size of 40 sq. m (8m×5m) was maintained. The compositions evaluated include Zinc salt, Iron salt, Magnesium salt alone and different formulations including combinations of water insoluble Zinc salt, water insoluble Iron salt, water insoluble Magnesium salt, where Zinc salt, Iron salt, Magnesium salt were applied in each treatment at same dosages. The compositions were applied via bend/side placement just before flowering stage of the tomato crop.

The tomato crop in the trial field was raised following good agricultural practices. The seed of Tomato, variety Veer 2182, were used for the study and planted in 120 cm row to row and 45 cm plant to plant spacing. The details of the experiment are as follows:

### Details of Experiment

a) Trial Location: Jaulkedindori, Nasik (MH)
b) Crop: Tomato (variety Veer 2182)
c) Experiment season: Kharif 2021
d) Trial Design: Randomized Block Design
e) Replications: Four
f) Treatment: Six
g) Plot size: 8m×5m=40 sq. m
h) Date of Application: 27 Jul. 2021
i) Method of application: Bend/side placement
j) Date of transplanting: 20 Aug. 2021
k) Date of Pickings: 1st—3 Oct. 2021; 2nd—11 Oct. 2021;
   3rd—16 Oct. 2021; 4th—22 Oct. 2021
   5th—28 Oct. 2021; 6th—4 Nov. 2021

The observations on fruit setting were carried out by tagging newly opened blossoms once a week, and counting the number of tagged blossoms which set fruits one week later. The fruits were harvested six times and weighed each time. The mean data of all the observations were presented in Table 4 to illustrate the impact of combination comprising water insoluble salt of Zinc, water insoluble salt of Magnesium and water insoluble salt of Iron in water dispersible granular form as per the embodiment of the present invention as well as in pastille form and powder form, on Tomato yield and other parameters.

TABLE 4

| | | | | Tomato | | | |
|---|---|---|---|---|---|---|---|
| | | | | weight | | | |
| | Dose of nutrient salt in | | | (g fruit | Tomato | % | Expected |
| | g/ha | | | weight/ | Yield | Yield | % Yield |
| Treatment Details | Zinc | Iron | Magnesium | plant) | (Kg/ha) | increase | increase |
| T1-Zinc Silicate | 469.52 | 328.59 | 313.81 | 437 | 3500 | 9.03 | 13.93 |
| 20% + Iron Silicate | | | | | | | |
| 25% + Magnesium | | | | | | | |
| Silicate Hydrate | | | | | | | |
| 45%-Pellet | | | | | | | |
| T2-Zinc Silicate | 469.52 | 328.59 | 313.81 | 455 | 3554 | 10.72 | 13.93 |
| 20% + Iron Silicate | | | | | | | |
| 25% + Magnesium | | | | | | | |
| Silicate Hydrate | | | | | | | |
| 45%-Powder | | | | | | | |
| T3-Zinc Silicate | 469.52 | 328.59 | 313.81 | 505 | 4050 | 26.17 | 13.93 |
| 20% + Iron Silicate | | | | | | | |
| 25% + Magnesium | | | | | | | |
| Silicate Hydrate | | | | | | | |
| 45%-WDG prepared | | | | | | | |
| as per the | | | | | | | |
| embodiment of the | | | | | | | |
| present invention | | | | | | | |
| T4-Zinc Silicate | 469.52 | — | — | 427 | 3390 | 5.61 | — |
| 20% WDG | | | | | | | |
| T5-Iron Silicate | — | 328.59 | — | 422 | 3340 | 4.05 | — |
| 25% WDG | | | | | | | |
| T6-Magnesium | — | — | 313.81 | 418 | 3370 | 4.98 | — |
| Silicate Hydrate | | | | | | | |
| 45% WDG | | | | | | | |
| T7-Zinc Oxide | 265.12 | 256.55 | 402.73 | 432 | 3450 | 7.48 | 9.21 |
| 10% + Iron (II) | | | | | | | |
| Oxide 10% + | | | | | | | |
| Magnesium Silicate | | | | | | | |
| Hydrate 70%-Pellet | | | | | | | |
| T8-Zinc Oxide | 265.12 | 256.55 | 402.73 | 454 | 3483 | 8.50 | 9.21 |
| 10% + Iron (II) | | | | | | | |
| Oxide 10% + | | | | | | | |
| Magnesium Silicate | | | | | | | |
| Hydrate 70%- | | | | | | | |
| Powder | | | | | | | |
| T9-Zinc Oxide | 265.12 | 256.55 | 402.73 | 515 | 3930 | 22.43 | 9.21 |
| 10% + Iron (II) | | | | | | | |
| Oxide 10% + | | | | | | | |
| Magnesium Silicate | | | | | | | |
| Hydrate 70%-WDG | | | | | | | |
| prepared as per the | | | | | | | |
| embodiment of the | | | | | | | |
| present invention | | | | | | | |
| T10-Zinc Oxide | 265.12 | — | — | 420 | 3290 | 2.49 | — |
| 10%WDG | | | | | | | |
| T11-Iron (II) Oxide | — | 256.55 | — | 418 | 3305 | 2.96 | — |
| 10% WDG | | | | | | | |
| T12-Magnesium | — | — | 402.73 | 425 | 3340 | 4.05 | — |
| Silicate Hydrate | | | | | | | |
| 70% WDG | | | | | | | |
| T13-Untreated | — | — | — | 400 | 3210 | — | — |
| CD at 0.05% | — | — | — | — | — | — | — |

It can be clearly seen from the Table 4 above that the treatment T3 with Zinc Silicate 20%+Iron Silicate 25%+Magnesium Silicate Hydrate 45%−WDG, as per the embodiment of the present invention showed a yield increase of 26.17% in Tomato fruit. However, treatment T1 with Zinc Silicate 20%+Iron Silicate 25%+Magnesium Silicate Hydrate 45%−Pellet demonstrated only an increase of 9.03% while treatment T2 with Zinc Silicate 20%+Iron Silicate 25%+Magnesium Silicate Hydrate 45%−Powder demonstrated only an increase of 10.72% in the yield of Tomato fruits. Based on the data and the calculations made by referring the treatments T1-T6, the expected percentage increase in the fruit yield was 13.93%. Thus, it can be noted that the treatment T3-WDG as per the present invention demonstrated a synergistic effect, as compared to the same treatment with pastille or with powder compositions. i.e. Treatments T1, T2 respectively as well as the application of individual actives i.e. Treatments T4-T6 despite being applied at same dosage of applications of Zinc, Iron and Magnesium respectively. The results are all the more surprising as all the treatments T1 to T6 had the same dosage of Zinc, Iron and Magnesium being applied to the soil i.e. 469.52 gm/ha of Zinc, 328.59 gm/ha of Iron and 313.81 gm/ha of Magnesium.

Further, treatment T9 with Zinc Oxide 10%+Iron (II) Oxide 10%+Magnesium Silicate Hydrate 70%−WDG exhibited highest fruit yield of about 515 g when compared to treatment T7 with Zinc Oxide 10%+Iron (II) Oxide 10%+Magnesium Silicate hydrate 70%−Pellet (a fruit yield of 432 g), Treatment T8 with Zinc Oxide 10%+Iron (II) Oxide 10%+Magnesium Silicate Hydrate 70%−Powder (fruit yield—454 g). It was further observed that treatments T3 and T9 with composition as per the embodiment of the present invention showed increased greenness and improved fruit size and colour in Tomato, as compared to pastille and powder compositions i.e. treatments T1-T2 and T7-T8 respectively.

It was thus noted that composition of “water insoluble Iron salt, water insoluble Zinc salt and water insoluble Magnesium salt” in the form of a water dispersible granule as per the embodiments of the present invention is synergistic in nature and showed a surprising enhancement in the yield as well as improved plant physiological parameters as compared to other known formulation types.

### Experiment No. 5: To Study the Effect of Water Dispersible Granular Composition of Present Invention in Brinjal

The trial was laid out during Rabi season i.e. January to April in Randomized Block Design (RBD) with five treatments including untreated control, replicated four times. The compositions evaluated include WDG composition of Zinc salt and Iron salt and WDG composition of the present invention as soil application after planting of brinjal seedlings in the trial plot. The brinjal crop in the trial field was raised following good agricultural practices.

### Details of Experiment

a) Trial Location: Dehgam, Gandhinagar
b) Crop: Brinjal
c) Experiment season: Rabi
d) Trial Design: RBD
e) Replications: Five
f) Treatments: Five
g) Plot size: 5×6=30 sqm
h) Date of sowing: 10 Dec. 2021
i) Date of Application: 10 Dec. 2021
j) Method of application: Soil application near root zone
k) Crop variety: MAHY Super-10
l) Date of Harvesting: 10 Mar. 2022
m) Soil pH: 6-6.5

The observations were recorded at the harvesting time and the mean data was presented in Table 5 to enumerate the efficacy of the water dispersible granules comprising “Water insoluble Zinc salt and Water insoluble Magnesium salt and water insoluble Iron salt” prepared as per the embodiment of the present invention.

TABLE 5

| | | | | | | % Yield |
|---|---|---|---|---|---|---|
| | Formulation | Dose of nutrient (g/ha) | | | | increase |
| | dose | Zinc | Iron | Magnesium | Yield | over |
| Treatment Details | (g/ha) | (Zn) | (Fe) | (Mg) | (Kg/ha) | untreated |
| T1-Zinc Sulphide 20% + | 4000.0 | 536.62 | 335.69 | | 2400 | 14.01 |
| Ferric Oxide 12%- | | | | | | |
| WDG | | | | | | |
| T2-Zinc Sulphide 25% + | 3200.0 | 536.62 | 335.69 | 278.94 | 2965 | 40.86 |
| Ferric Oxide 15% + | | | | | | |
| Magnesium Silicate | | | | | | |
| Hydrate 50%-WDG | | | | | | |
| prepared as per the | | | | | | |
| embodiment of the | | | | | | |
| present invention | | | | | | |
| T3-Zinc Borate 16% + | 6500.0 | 650.05 | 202.13 | | 2297.5 | 9.14 |
| Ferrous Oxide 4%- | | | | | | |
| WDG | | | | | | |
| T4-Zinc Borate 4% + | 26000.0 | 650.05 | 202.13 | 599.75 | 3012.5 | 43.11 |
| Iron (II) oxide 1% + | | | | | | |
| Magnesium Oxide 8%- | | | | | | |
| WDG prepared as per | | | | | | |
| the embodiment of the | | | | | | |
| present invention | | | | | | |
| T5-Commercial multi- | 30000 | | | | 2480 | 17.81 |
| nutrient sample Powder- | | | | | | |
| Microfood (Tstanes) | | | | | | |
| T6-Untreated | | | | | 2105 | |
| CD (P > 0.05) | — | — | — | | | |

| | Uptake of Nutrients (mg/100 gm of Brinjal Fruit) | | | | |
|---|---|---|---|---|---|
| Treatment Details | Zn | Fe | Mg | Ca | B |
| T1-Zinc Sulphide 20% + Ferric | 0.21 | 0.13 | 4.6 | 3.5 | 1.9 |
| Oxide 12%-WDG | | | | | |
| T2-Zinc Sulphide 25% + Ferric | 2.67 | 3.22 | 20 | 10 | 3.5 |
| Oxide 15% + Magnesium | | | | | |
| Silicate Hydrate 50%-WDG | | | | | |
| prepared as per the embodiment | | | | | |
| of the present invention | | | | | |
| T3-Zinc Borate 16% + Ferrous | 0.5 | 0.4 | 4.5 | 3.9 | 2 |
| Oxide 4%-WDG | | | | | |
| T4-Zinc Borate 4% + Iron (II) | 3.67 | 3.9 | 16 | 9 | 4 |
| oxide 1% + Magnesium Oxide | | | | | |
| 8%-WDG prepared as per the | | | | | |
| embodiment of the present | | | | | |
| invention | | | | | |
| T5-Commercial multi-nutrient | 1.2 | 1.7 | 8 | 4.1 | 1.5 |
| sample Powder-Microfood | | | | | |
| (Tstanes) | | | | | |
| T6-Untreated | 0.1 | 0.12 | 4.5 | 3.1 | 1.1 |
| CD (P > 0.05) | | | | | |

It can be observed from Table 5 that the WDG composition comprising Zinc salt, Iron salt and Magnesium salt as per the embodiment of the present invention shows a significant enhancement in the uptake of nutrients as compared to the uptake observed with the application of WDG composition of Zinc salt+Iron salt at an acidic soil pH condition where the active Zn and Fe were applied at same active dosage. For instance: Treatment T2 with Zinc Sulphide 25%+Ferric Oxide 15%+Magnesium Silicate Hydrate 50%−WDG prepared as per the embodiment of the present invention demonstrates an uptake of 2.67 mg of Zinc, 3.22 mg of Iron and 20 mg of Magnesium while treatment T1 with Zinc Sulphide 20%+Ferric Oxide 12%−WDG which is devoid of Magnesium shows a reduced uptake of 0.21 mg of Zinc, 0.13 mg of Iron and 4.6 mg of Magnesium where the uptake of zinc and iron was found to be very low even at acidic soil pH which is generally considered favorable for nutrient uptake. This appreciable increase in the availability of Zinc and Iron observed in Treatment T2 was noted to be on account of the presence of Magnesium along with Zinc and Iron in the composition formulated as per the embodiment of the invention i.e., in the form of a water dispersible granules with particle size in the range of 0.1 microns to 20 microns in Treatment T2 which facilitated the increased availability of the entire range of micronutrients present in the composition i.e., Magnesium Iron and Zinc for uptake by the crops.

Further, the application of Treatment 4 with Zinc Borate 4%+Iron (II) Oxide 15%+Magnesium Oxide 1%−WDG according to an embodiment of the present invention showed an increase of 43.11% in yield of Brinjal fruit as compared to treatment T3 which showed 9.14% in yield of Brinjal fruit. The enhancement in efficacy with the composition as per the embodiment of the present invention is surprising as the dosages of Zinc and Iron applied in WDG composition the as per the present invention as well as the two-way treatment which is devoid of Magnesium i.e. T3 are the same. Further, similar results were observed in case of Treatment T2 of the present invention when compared to Treatment T1 of two-way composition of Zinc salt+Iron salt.

In addition, the surprising efficacy observed in terms of fruit yield of Brinjal for the treatments T2 and T4 where the three actives are present as per the embodiment of the present invention i.e., in a single composition and in specific concentration, wherein the composition comprises particles in the size range of 0.1 micron to 20 microns. It was further noted that the treatments T2 and T4 with a yield increase of about 40.86% and 43.11% respectively demonstrated higher efficacy when compared to the commercially available micronutrient mixture i.e. Treatment T5 which despite being applied at high formulation dosage showed a yield increase of only 17.81%.

It was further observed that with Treatment T5, the uptake of Zinc, Iron and Magnesium was found to be 1.2 mg, 1.7 mg and 8 mg respectively and with Treatment T3 the uptake of Zinc, Iron and Magnesium was found to be 0.5, 0.4 mg, and 4.5 mg respectively. On the other hand, with Treatment T4 the uptake of Zinc, Iron and Magnesium was found to be 3.67 mg, 3.9 mg and 16 mg respectively. This appreciable increase in the availability of Zinc and Iron observed in Treatment T4 was noted to be on account of the presence of Magnesium along with Zinc and Iron in the composition formulated as per the embodiment of the invention i.e., in the form of a water dispersible granules with particle size in the range of 0.1 microns to 20 microns in Treatment T4 which facilitated the increased availability of the entire range of micronutrients present in the composition i.e., Magnesium Iron and Zinc for uptake by the crops. It was thus noted that the composition comprising a combination of water insoluble Zinc salt and water insoluble Magnesium salt and water insoluble Iron salt in the form of water dispersible granules demonstrates a better uptake of Magnesium, Zinc and Iron when compared to commercially available multi-nutrient powder composition as well as an application of a composition of only Iron and Zinc which is devoid of Magnesium.

From the aforementioned data, it can be concluded that the composition comprising of “water insoluble Zinc salt and water insoluble Magnesium salt and water insoluble Iron salt” in the form of WDG as per the embodiment of the present invention at different dosages and at claimed concentration ranges demonstrated significantly higher uptake of micronutrients, higher yield.

The inventors of the present invention surprisingly noted that the presence of Magnesium in the present composition not only enhanced the uptake of Iron and Zinc but also of other micro nutrients entrapped in soil such as Calcium, Boron etc. which hitherto were not quite available to the plant. The results of enhanced uptake of the entrapped micronutrients like Boron, Calcium can also be noted from the results presented in Table 5 which shows that Treatment T2, T4 have highest values of uptake of Calcium and Boron as compared to that of Treatments T1, T3, T5 and untreated control.

Thus, a composition of present invention in the form of a water dispersible granular composition was found to be high nutrient use efficient fertilizer.

### Experiment No. 6: To Study the Effect of the Composition of the Present Invention on Uptake of Zinc, Magnesium and Iron in Different Soil pH Conditions

Pot trial experiments were carried out to observe the effect of the composition of the present invention in the form of WDG on the availability of Zinc, Magnesium and Iron in different soil types over a period of time on Onion Crop in Poly-house at Nashik, Maharashtra (India).

The 5 pots, sized with 20 cm top diameter×15.5 cm bottom diameter×16.5 cm height, for each treatment were arranged in Randomized Block Design (RBD) and labelled in order to make two treatment for each experiment.

The Test Nutritional compositions as indicated below at prescribed dose were measured based on surface area calculation of soil and applied in the respective treatment pots on top soil and mixed in soil well up to 5 cm depth. Thereafter, a 25 days old onion seedling was planted in each pot. The planted onion seedlings in the 5 pots were raised with GAP (Good Agricultural Practice) until harvesting or full development of Onion bulb.

The Treatment Details are as follows:

$$T 1 - Zinc Oxide 15 \% + Iron ( III ) Oxide 10 \% + Magnesium Silicate Hydrate 60 \% - WDG$$

$$T 2 - Zinc Oxide 15 \% + Iron ( III ) Oxide 10 \% - WDG$$

The Details of the Experiment are as follows:
a) Trial Location: Nasik (Maharashtra
b) Crop: Onion (var. Nasik red)
c) Experiment season: Rabi 2021-2022
d) Trial Design Randomized Block Design with 5 pot in each treatment
e) Replications: 13
f) Treatment: 7
g) Pot size: 20 cm top diameter×15.5 cm bottom diameter×16.5 cm height
h) Date of Application: 22 Nov. 2021
i) Date of seedling planting: 22 Nov. 2021
j) Method of application: Basal (Soil Application)
k) Date of Harvesting: 2 Mar. 2022

The observations on uptake on nutrients were recorded at the harvesting time and mean data was presented in Tables 6A, 6B, 6C to enumerate the availability of Zinc, Magnesium and Iron in different pH conditions.

TABLE 6A
Tests were performed in Alkaline Soil (pH-8.5 to 9) to assess the nutrient availability
from different treatments and mean values were presented as below

| | | Active ingredients (g/ha) | | | | | |
|---|---|---|---|---|---|---|---|
| | Formulation | Zinc | Iron | Magnesium | Nutrient concentration in | | |
| | dosage in | (Zn) | (Fe) | (Mg) | mg/100 g of Onion Bulb | | |
| Compositions | g/ha | content | content | content | Mg | Fe | Zn |
| T1-Zinc Oxide | 4500.0 | 542.29 | 314.77 | 470.72 | 14 | 1.12 | 1.0 |
| 15% + Iron (III) | | | | | | | |
| Oxide 10% + | | | | | | | |
| Magnesium | | | | | | | |
| Silicate | | | | | | | |
| Hydrate 60%- | | | | | | | |
| WDG prepared | | | | | | | |
| as per the | | | | | | | |
| embodiment of | | | | | | | |
| the present | | | | | | | |
| invention | | | | | | | |
| T2-Zinc Oxide | 4500.0 | 542.29 | 314.77 | — | 1.5 | 0.06 | 0.08 |
| 15% + Iron (III) | | | | | | | |
| Oxide 10%- | | | | | | | |
| WDG | | | | | | | |
| T3-Untreated | — | — | — | — | 0.5 | 0.01 | 0.02 |

TABLE 6B
Tests were performed in Acidic soil (pH-6 to 6.5) to assess the nutrient availability
from different treatments and mean values were presented as below

| | | Active ingredients (g/ha) | | | | | |
|---|---|---|---|---|---|---|---|
| | Formulation | Zinc | Iron | Magnesium | Nutrient concentration in | | |
| | dosage in | (Zn) | (Fe) | (Mg) | mg/100 g of Onion Bulb | | |
| Compositions | g/ha | content | content | content | Mg | Fe | Zn |
| T1-Zinc | 4500.0 | 542.29 | 314.77 | 470.72 | 18 | 2.0 | 1.5 |
| Oxide 15% + | | | | | | | |
| Iron (III) | | | | | | | |
| Oxide 10% + | | | | | | | |
| Magnesium | | | | | | | |
| Silicate | | | | | | | |
| Hydrate | | | | | | | |
| 60%-WDG | | | | | | | |
| prepared as | | | | | | | |
| per the | | | | | | | |
| embodiment | | | | | | | |
| of the present | | | | | | | |
| invention | | | | | | | |
| T2-Zinc | 4500.0 | 542.29 | 314.77 | — | 2.0 | 0.18 | 0.22 |
| Oxide 15% + | | | | | | | |
| Iron (III) | | | | | | | |
| Oxide 10%- | | | | | | | |
| WDG | | | | | | | |
| T3-Untreated | — | — | — | — | 2.0 | 0.06 | 0.09 |

TABLE 6C
Tests were performed in Neutral Soil (pH-7) to assess the nutrient availability
from different treatments and mean values were presented as below

| | | Active ingredients (g/ha) | | | | | |
|---|---|---|---|---|---|---|---|
| | Formulation | Zinc | Iron | Magnesium | Nutrient concentration in | | |
| | dosage in | (Zn) | (Fe) | (Mg) | mg/100 g of Onion Bulb | | |
| Compositions | g/ha | content | content | content | Mg | Fe | Zn |
| T1-Zinc Oxide | 4500.0 | 542.29 | 314.77 | 470.72 | 15 | 1.18 | 1.2 |
| 15% + Iron (III) | | | | | | | |
| Oxide 10% + | | | | | | | |
| Magnesium | | | | | | | |
| Silicate Hydrate | | | | | | | |
| 60%-WDG | | | | | | | |
| prepared as per | | | | | | | |
| the embodiment | | | | | | | |
| of the present | | | | | | | |
| invention | | | | | | | |
| T2-Zinc Oxide | 4500.0 | 542.29 | 314.77 | — | 1.5 | 0.12 | 0.15 |
| 15% + Iron (III) | | | | | | | |
| Oxide 10%- | | | | | | | |
| WDG | | | | | | | |
| T3-Untreated | — | — | — | — | 0.18 | 0.03 | 0.07 |

From Table 6B & Table 6C, it was noted that Zinc and Iron were moderately available for uptake with Treatment T2 when applied in both acidic soil and neutral soil pH respectively as compared to those observed with Treatment T2 (Table 6A) where the soil pH was alkaline despite the same treatment i.e. Zinc Oxide 15%+Iron (III) Oxide10%−WDG was applied at same active dosage of Zinc and Iron.

It was further observed from Tables 6A, 6B and 6C that when treatment T1 with Zinc Oxide 15%+Iron (III) Oxide 10%+Magnesium Silicate Hydrate 60%−WDG as per the embodiment of the present invention was applied, the uptake of nutrients like Zinc, Magnesium and Iron was found to be comparatively same at all soil pH conditions. Upon comparing the results presented for the Treatments T1, T2 of Table 6A, it was further surprising to observe that the uptake of Zinc and Iron was found to be substantially increased with Treatment T1 (as per the embodiment of the present invention) where Magnesium Silicate Hydrate was added to the composition of Zinc Oxide 15%+Iron (III) Oxide 10%−WDG despite the pH being alkaline, which was not observed with treatment T2.

It is thus noted that, the WDG composition of “water insoluble Iron salt, water insoluble zinc salt and water insoluble Magnesium salt” as per the embodiments of the present invention depicts significantly higher uptake of Iron and Zinc even at alkaline pH which was not observed with two-way mixture of Iron salt and Zinc salt at same pH. It can be appreciated from the observed results that on account of the presence of Magnesium along with Zinc and Iron in the composition formulated as per the embodiment of the invention i.e., in the form of a water dispersible granules with particle size in the range of 0.1 microns to 20 microns facilitates the uptake of Iron and Zinc in alkaline soil which was not observed with the composition devoid of Magnesium i.e. treatment T2.

Further, the Treatment T1-WDG as per the embodiments of the present invention was found to be nutrient use efficient and demonstrates good update of all the three nutrients in acidic, neutral as well as alkaline pH soil conditions.

### Experiment No. 7: To Compare the Effect of Composition of Present Invention Vis-à-Vis Commercially Available Water-Soluble Powder of Multi-Nutrient in Tomato Crop

The field trial was carried out on a commercially cultivated tomato field at Nashik in Maharashtra to compare the effect of a WDG composition comprising a combination of water insoluble salts of Zinc, Magnesium and Iron vis-a-vis commercially available water-soluble multi-nutrient powder, a product “SPIC Nourish” (comprising Zn, Fe, Mn, B, Mg, Cu) in Tomato. The trial was laid out during January 2022 to May 2022 spring season in Randomized Block Design (RBD) with five treatments including untreated control. The compositions of the present invention with prescribed dose were applied along with drip irrigation at 20 days after planting.

The Tomato crop in trial field was raised following good agricultural practice. The tomato seedling of variety Avinash was used for planting in trials field and planted in 120 cm row to row and 45 cm plant to plant spacing.

### Details of Experiment

a) Trial Location: Nasik (MH)
b) Crop: Tomato-Variety ‘Avinash’
c) Experiment season: Spring season (January 2022 to May 2022)
d) Trial Design: Randomized Block Design
e) Replications: Seven
f) Treatment: Three
g) Plot size: 8m×5m=40 sq. m
h) Date of planting: 9 Jan. 2022
i) Date of Application: 30 Jan. 2022
j) Method of application: Soil application by drip system

TABLE 7

| | | Tomato | | |
|---|---|---|---|---|
| | Formula- | weight | Tomato | |
| | tion | (gram fruit | Yield of 3 | |
| | Dose in | weight/ | pickings | % Yield |
| Treatment Details | Kg/ha | plant) | (Kg/ha) | increase |
| T1- Zinc Oxide 1% + Iron | 19 | 505 | 3960 | 31.56 |
| (II) Fumarate 6% + | | | | |
| Magnesium Hydroxide | | | | |
| 10%-WDG as per the | | | | |
| embodiment of present | | | | |
| invention | | | | |
| T2- SPIC Nourish - | 25 | 400 | 3240 | 7.64 |
| Commercially available | | | | |
| water soluble multi- | | | | |
| nutrient powder | | | | |
| (comprising Zn, Fe, Mn, B, | | | | |
| Mg, Cu) | | | | |
| T3-Untreated | — | 370 | 3010 | — |

It can be observed from treatment T1 of Table 7 that a WDG composition prepared according to an embodiment of the present invention demonstrated better yield as compared to treatment T2 wherein the composition applied is a commercially available water soluble multi-nutrient mixture and the untreated plot. Treatment T1 depicted yield increase of about 31.56% despite being applied at reduced a dosage when compared to treatment T5 which had yield increase of only 7.64%. Further, the tomato fruit weight by application of T1 and T2 was observed to be 505 g/plant and 400 g/plant respectively. Thus, it can be concluded that even at a reduced dosage, the combination of “water insoluble Iron salt, water insoluble Zinc salt and water insoluble Magnesium salt” in the form of WDG as per the embodiment of the present invention shows significant improvement in fruit weight, fruit yield than that of the commercially available water soluble multi-nutrient mixture.

### Experiment 8: To Study the Effect of WDG Composition of the Present Invention in Comparison to Traditional Fertilizer Practices

The field trials were carried out to determine the effect of composition of the present invention on availability of nutrients with that of the application of traditional fertilizer practices in calcareous soil at Junagadh, Gujarat (India) on Onion crop, variety: Kasturi 108. The trials were laid down in Randomized Block Design (RBD) with three treatments including untreated control, replicated seven times. For each treatment, plot size of 40 sq. m (8m×5m) was maintained.

Soil was analyzed to assess nutrient availability before the date of application of treatment and the observations are as follow:

| N | P | K | S | Zn | Fe | Mn | Mg | Ca | B | Cu | Mo | Other |
|---|---|---|---|---|---|---|---|---|---|---|---|---|
| 200 | 21.3 | 569 | 19.3 | 2.57 | 8.44 | 3.01 | 190 | 734 | 0.194 | 1.47 | NA | 7.23% |
| kg/ha | kg/ha | kg/ha | ppm | ppm | ppm | ppm | ppm | ppm | ppm | ppm | | (Calcium |
| | | | | | | | | | | | | carbonate); |
| | | | | | | | | | | | | Carbon- |
| | | | | | | | | | | | | 0.44%; |
| | | | | | | | | | | | | Na- |
| | | | | | | | | | | | | 163 ppm |

The Details of the Experiment are as follows:
a) Trial Location: Junagadh (Gujarat)
b) Crop: Onion (var. Red Onion-11)
c) Experiment season: Rabi 2021-2022
d) Trial Design: Randomized Block Design with 5 pot in each treatment
e) Replications: 7
f) Treatment: 3
g) Pot size: 8m×5m=40 sq. m
h) Date of Application: 20 Dec. 2021
i) Date of seedling planting: 20 Dec. 2021
j) Method of application: Basal (Soil Application)
k) Date of Harvesting: 5 Apr. 2022
l) Soil pH: 8.35

The observations on the availability of nutrients in onion crop were recorded at the harvesting time and mean data were presented in Table 8 to enumerate the effect of composition of present invention in the calcareous soil.

TABLE 8

| | | | | | | | | NPK uptake | | |
|---|---|---|---|---|---|---|---|---|---|---|
| | Formulation | Nutrient uptake | | | | | | Kg/ha of final produce | | |
| | dosage in | (mg/100 gm of Onion bulb) | | | | | | (Onion bulb & leaves) | | |
| Treatment Details | g/ha | Zn | Fe | Mg | Mn | Ca | B | N | P | K |
| T1-Zinc Oxide | 1500 | 2.20 | 8.14 | 170 | 2.90 | 500 | 0.17 | 120 | 18 | 400 |
| 30% + Ferric Oxide | | | | | | | | | | |
| 25% + Magnesium | | | | | | | | | | |
| Oxide 35%-WDG | | | | | | | | | | |
| T2-NPK traditional | 1000 | 0.90 | 2.20 | 51 | 1.10 | 250 | 0.03 | 80 | 11 | 250 |
| fertilizer 19:19:19 | | | | | | | | | | |
| (water soluble | | | | | | | | | | |
| commercially | | | | | | | | | | |
| available mixture) | | | | | | | | | | |
| T3-Nutrifast | 2500 | 1.10 | 3.0 | 50 | 1.40 | 200 | 0.05 | 75 | 9 | 230 |
| (commercially | | | | | | | | | | |
| available water- | | | | | | | | | | |
| soluble product by | | | | | | | | | | |
| Stanes) (40% NPK + | | | | | | | | | | |
| 5% micronutrient | | | | | | | | | | |
| mixture) | | | | | | | | | | |
| T4-Untreated | | 0.04 | 0.12 | 20 | 0.40 | 250.00 | 0.01 | 70 | 8 | 200 |

It can be observed from Table 8 that treatment T1—a WDG composition prepared according to an embodiment of the present invention demonstrated better uptake of nutrients in calcareous soil as compared to treatments T2 and T3 i.e. commercially available water soluble NPK fertilizers and commercially available NPK with water soluble micronutrient composition (Nutrifast by Stanes) respectively as well as over the untreated plot.

It was observed that the practice of application of NPK and NPK with other micronutrients such as Calcium, Boron, Manganese etc. even at higher dosage of application did not meet the nutritional requirement of the plant and failed to provide even an adequate uptake of Zinc, Iron and Magnesium along with other nutrients as observed with the composition of the present invention. Thus, it can be noted that despite being applied in calcareous soil, the combination of water insoluble Iron salt, water insoluble Zinc salt and water insoluble Magnesium salt in the form of WDG as per the embodiment of the present invention shows significant nutrient availability to the plant as compared to treatments T2 and T3 i.e. synthetic fertilizer mixtures.

It can be appreciated from the observed results that on account of the presence of Magnesium along with Zinc and Iron in the composition formulated as per the embodiment of the invention i.e., in the form of a water dispersible granules with particle size in the range of 0.1 microns to 20 microns not only there is an uptake of Iron and Zinc in calcareous soil but also of other micronutrients including Manganese, Calcium, Boron etc. which was not observed with the commercially available water soluble NPK fertilizers and commercially available NPK with water soluble micronutrient composition i.e. treatments T2, T3. The present invention not only facilitates assimilation of essential nutrients like Magnesium, Zinc and Iron but also assist in unlocking the micronutrients and trace elements making them available for uptake by plants which were not available for uptake in mineral rich calcareous soil primarily because of reported antagonism between Ca—Mg, Ca—Fe and Ca—Zn.

Further, the inventors of the present invention also tested the WDG composition of the present invention on other crops like Chili, Chickpea. It was observed that the composition of the present invention may further enhance crop characteristics like straw weight, plant height and also add to nutritional value of the crop. Further such combinations may additionally help in improving the crop yield, improved photosynthesis, increase chlorophyll content and uptake of nutrients by the crop.

It has been observed that the composition of the present invention, demonstrates enhanced, efficacious and superior behavior in the fields. Through the composition of the present invention, the number of applications or the amount of nutrients, fertilizers or pesticides are minimized. Moreover, the present composition exhibits a surprisingly higher field efficacy at reduced dosages of application of the composition as compared to prior known composition. The composition is highly safe for the user and for the environment. This novel composition helps to improve plant yield, balanced uptake of all nutrients, reduce yellowing of leaves and plant physiological parameters such as increased rooting, improved foliage, disease resistance, increased greenness of the crops providing a nutritionally rich crop.

Further, the various advantageous properties associated with the compositions according to the invention, include but are not limited to improved stability, improved toxicological and/or ecotoxicological behavior, improved crop characteristics including crop yields, crop qualities and characteristics and other advantages familiar to a person skilled in the art.

From the foregoing, it will be observed that numerous modifications and variations can be effectuated without departing from the true spirit and scope of the novel concepts of the present invention. It is to be understood that no limitation with respect to the specific embodiments illustrated is intended or should be inferred.

1.-15. (canceled)

16. A water dispersible granular crop nutrition composition comprising a homogeneous mixture of:
at least one water insoluble Iron salt, complex, or derivative thereof in a range of 1-50% w/w of the water dispersible granular crop nutrition composition,
at least one water insoluble Zinc salt, complex, or derivative thereof in a range of 1-50% w/w of the water dispersible granular crop nutrition composition,
at least one water insoluble Magnesium salt, complex, or derivative thereof in a range of 1-80% w/w of the water dispersible granular crop nutrition composition,
at least one agrochemically acceptable excipient in a range of 0.01-97% w/w of the water dispersible granular crop nutrition composition,
wherein granules of the water dispersible granular crop nutrition composition are in a size range of 0.05-4.0 mm, and wherein the granules comprise particles in a size range of 0.1 micron-20 microns.

17. The water dispersible granular crop nutrition composition of claim 16, wherein the at least one water insoluble Iron salt, complex, or derivative thereof comprises at least one of Iron Oxide, Iron Succinate, Iron Fumarate, Iron Hydroxide, Iron Oxalate, Iron Sucrate, Iron Tartrate, Iron Phosphate, Iron Carbonate, Iron Silicate, Carbonyl Iron, Iron Sulphide, and Iron Dichromate.

18. The water dispersible granular crop nutrition composition of claim 16, wherein the at least one water insoluble Zinc salt, or complex, or derivative thereof comprises at least one of Zinc Oxide, Zinc Carbonate, Zinc Sulphide, Zinc Molybdate, Zinc Phosphate, Zinc Nitrilotriacetic Acid, Zinc Borate, Zinc Silicate, Zinc Pyrophosphate, and Zinc Citrate.

19. The water dispersible granular crop nutrition composition of claim 16, wherein the at least one water insoluble Magnesium salt, or complex, or derivative thereof comprises at least one of Magnesium Molybdate, Magnesium Hydroxide, Calcium Magnesium Phosphate, Magnesium Carbonate, Magnesium Aluminium Silicate, Calcium Magnesium Silicate, Magnesium Trisilicate, Magnesium Silicate, Magnesium Oxide.

20. The water dispersible granular crop nutrition composition of claim 16, wherein the water dispersible granular crop nutrition composition comprises particles in a size range of 0.1 micron to 10 microns.

21. The water dispersible granular crop nutrition composition of claim 16, wherein the water dispersible granular crop nutrition composition comprises particles having a diameter distribution of D90 of about 15 microns.

22. The water dispersible granular crop nutrition composition of claim 16, wherein the at least one agrochemically acceptable excipient is selected from one or more of wetting agents, surfactants, dispersing agents, disintegrating agents, emulsifiers, fillers or carriers or diluents, spreading agents, colorants, anticaking agents, binders, buffers or pH adjusters or neutralizing agents, tackifiers, pigments, stabilizers, antifoaming agents or defoamers, anti-settling agents, penetrants, preservatives.

23. The water dispersible granular crop nutrition composition of claim 22, wherein the water dispersible granular crop nutrition composition comprises at least one surfactant.

24. The water dispersible granular crop nutrition composition of claim 16, wherein suspensibility of the water dispersible granular crop nutrition composition is at least 30%.

25. A process for preparation of the water dispersible granular crop nutrition composition of claim 16, wherein the process comprises:
a. milling the homogeneous mixture in water to obtain a homogeneous slurry or wet mix,
b. drying the wet mix to obtain the water dispersible granular crop nutrition composition.

26. The water dispersible granular crop nutrition composition of claim 16, wherein the water dispersible granular crop nutrition composition is at least one of: a fertilizer composition, a nutrient composition, a crop strengthener composition, a soil conditioner composition, and a yield enhancer composition.

27. A method for improving plant health or yield, wherein the method comprises treating at least one of a plant, a plant propagation material, locus or parts thereof, a seed, seedling, or surrounding soil with the water dispersible granular crop nutrition composition of claim 16.

28. A method for treating plants and meeting nutritional requirement of the plants by enhancing uptake of Magnesium, Zinc, and Iron, wherein the method comprises:
application of a composition comprising a homogeneous mixture of:
at least one water insoluble Iron salt, complex, or derivative thereof in a range of 1-50% w/w of the composition,
at least one water insoluble Zinc salt, complex, or derivative thereof in a range of 1-50% w/w of the composition,
at least one water insoluble Magnesium salt, complex, or derivative thereof in a range of 1-80% w/w of the composition,
at least one agrochemically acceptable excipient in a range of 0.01-97% w/w of the composition,
wherein granules of the composition are in a size range of 0.05 mm-4.0 mm, and wherein the granules comprise particles in a size range of 0.1 micron-20 microns.
